(19) United States
(12) Patent Application Publication
(10) Pub. No.: US 2008/0020133 A1
(43) Pub. Date: Jan. 24, 2008

(54) Method of Producing Metal Oxide Film

(76) Inventors: Hiroyuki Kobori, Tokyo (JP); Koujiro Ohkawa, Tokyo (JP); Hiroki Nakagawa, Tokyo (JP); Yosuke Yabuuchi, Tokyo (JP); Keisuke Nomura, Tokyo (JP)

Correspondence Address: LADAS & PARRY LLP, 224 SOUTH MICHIGAN AVENUE, SUITE 1600, CHICAGO, IL, 60604, US

(21) Appl. No.: 11/718,341

(22) PCT Filed: Nov. 10, 2005
(86) PCT No.: PCT/JP05/20645

§ 371 Date: May 1, 2007

(30) Foreign Application Priority Data
Nov. 10, 2004 (JP) 2004-326903

(51) Int. Cl. B05D 7/24

(52) U.S. Cl. 427/126.4; 427/126.5; 427/126.6

(57) ABSTRACT

A metal oxide film producing method which is an inexpensive wetting coating by use of a metal oxide film forming-solution, and which enables to yield an even and dense metal oxide film having a sufficient film thickness even on a substrate, such as one having complicated structural part or one comprising porous materials. The method of producing a metal oxide film, comprises: a first metal oxide film-forming step of bringing a substrate into contact with a first metal oxide film forming-solution that has a metal salt or a metal complex as a metal source and at least one of an oxidizing agent and a reducing agent dissolved, and forming a first metal oxide film on the substrate; and a second metal oxide film-forming step of heating the substrate having the first metal oxide film up to a metal oxide film forming-temperature or higher, bringing the resultant into contact with a second metal oxide film forming-solution that has a metal salt or a metal complex dissolved as a metal source, and yielding a second metal oxide film.

### TECHNICAL FIELD

The present invention relates to a method of producing a metal oxide film which is a wet coating and which enables to provide a dense metal oxide film onto a substrate having a structural part while the film is made dense.

### BACKGROUND ART

Conventionally, it has been known that metal oxide films exhibit various excellent physical properties. By making good use of this characteristic, the films are used in broad fields of transparent electroconductive films, optical thin films, electrolytes for fuel cells, and the like. Examples of a method of producing such a metal oxide film include a sol-gel method, sputtering, CVD, PVD, and printing.

A problem in the methods for producing such metal oxide film is that it is difficult to form an even metal oxide film onto a substrate that has a structural part. For example, in sputtering, the shape-following properties are poor because of its operation mechanism. In printing, it is difficult to form a film onto a fine structural part which is smaller than fine ceramic particles contained in ink. In CVD, which is relatively good in shape-following properties, advantageous effects are produced onto parts such as a shallow groove having a simple shape. However, it is difficult to form an even metal oxide film onto a complicated structural part. Further, wet coatings such as a sol-gel method are inexpensive manners. However, the manners have problems that a film is not easily formed on a substrate having a complicated structural part and that a dense metal oxide film cannot be obtained.

Against such problems, suggested is a soft solution process of forming a metal oxide film directly from a solution onto a substrate (Non-Patent Document 1). In such soft solution process, a substrate is brought into contact with a metal oxide film-forming solution; therefore, even if the substrate is a substrate having a complicated structural part, the solution can be caused to invade the inside of the structural part easily. Accordingly, the process has an advantage of being able to produce an even metal oxide film.

As an example of an attempt to use this soft solution process, Patent Document 1 discloses a method of causing a reaction solution which contains constituting elements of a thin film to be formed to flow, at a predetermined flow rate, between an anode electrode and a cathode electrode to which a predetermined voltage is applied, thereby forming a thin film.

However, the method in Patent Document 1 has problems that the substrate is limited to electroconductive bodies, the film quality of the resultant thin film has coarse granularity, and a dense metal oxide film cannot be obtained. Moreover, the method has a further problem that the resultant metal oxide film is a thin film and thus a metal oxide film having a sufficient film thickness cannot be obtained.

As a different method of yielding a metal oxide film, a spray pyrolysis deposition method is proposed (Patent Documents 2 and 3). The spray pyrolysis deposition method is a method of spraying a solution containing a metal source which is to constitute a metal oxide film onto a high-temperature substrate, thereby yielding the metal oxide film. Since a substrate heated to about 500° C. is usually used, the solvent evaporates instantaneously so that the metal source undergoes pyrolysis reaction. Therefore, the method has an advantage that a metal oxide film can be obtained in a short time through a simplified step.

As an example of a research on the spray pyrolysis deposition method of example, Patent Document 2 discloses a method as follows. Adding hydrogen peroxide or aluminum acetylacetonate to a solution containing a TiO₂ precursor to prepare a starting material solution, spraying the solution intermittently onto a substrate kept at a high temperature of about 500° C., and thereby pyrolyzing the TiO₂ precursor to TiO₂ so as to yield a porous TiO₂ thin film on the substrate. As another example, Patent Document 3 is concerned with a method of yielding a porous TiO₂ thin film by the spray pyrolysis deposition method in the same manner as in Patent Document 2, and is a method of adding a solution containing a soluble titanium compound to a starting material solution, thereby improving the adhesive properties between the TiO₂ thin film and the substrate.

As described above, the spray pyrolysis deposition method is a method of yielding a metal oxide film in a short time through a simplified step; however, the method is easily affected by properties of the substrate surface. In particular, it is strongly affected, by the crystallinity of the substrate surface. Accordingly, for example, when the substrate has a complicated structural part or is made of a porous material, there arises a problem that a dense metal oxide film having an excellent crystallinity cannot be yielded.

Non-Patent Document 1: Journal of MMIJ (Shigen to Sozai) vol. 116, pp. 649-655 (2000)

Patent Document 1: Japanese Patent No. 3353070

Patent Document 2: Japanese Patent Application Laid-Open (JP-A) No. 2002-145615

Patent Document 3: JP-A No. 2003-176130

### DISCLOSURE OF THE INVENTION

Problems to be Solved by the Invention

In light of the above-mentioned problems, the invention has been made. A main object is to provide a metal oxide film producing method which is an inexpensive wetting coating by use of a metal oxide film forming-solution, and which enables to yield an even and dense metal oxide film having a sufficient film thickness even on, for example, a porous substrate or a substrate having a porous film without being affected by the crystallinity of its surface.

Means for Solving the Problems

To solve the problems, the present invention provides a method of producing a metal oxide film, comprising: a first metal oxide film-forming step of bringing a substrate into contact with a first metal oxide film forming-solution that has a metal salt or a metal complex as a metal source and at least one of an oxidizing agent and a reducing agent dissolved, and forming a first metal oxide film on the substrate; and a second metal oxide film-forming step of heating the substrate having the first metal oxide film up to a metal oxide film forming-temperature or higher, bringing the resultant into contact with a second metal oxide film forming-solution that has a metal salt or a metal complex dissolved as a metal source, and yielding a second metal oxide film.

In the invention, the first metal oxide film forming-solution is used in the first metal oxide film-forming step; thus, for example, even when the substrate has a structural part, the solution can easily invade the inside of the structural part, so that a first metal oxide film can be yielded in the structural part or on the surface. In the second metal oxide film-forming step, the substrate having the first metal oxide film is heated up to a metal oxide film forming-temperature or higher and the substrate is brought into contact with the second metal oxide film forming-solution, whereby a second metal oxide film can be formed on the first metal oxide film. As a result, an even and dense metal oxide film having a sufficient film thickness can be yielded. When the species of the metal sources contained in the first and second metal oxide film forming-solutions are varied, for example, different metal oxide films can be formed, between the inside of a porous material and the surface region thereof.

Further, it is preferable in the present invention to mix an oxidized gas at the time of bringing the first metal oxide film forming-solution into contact with the substrate. In particular, the oxidized gas is preferably oxygen or ozone. By the mixing of the oxidized gas, the film-forming speed of the metal oxide film can be improved.

In the invention, it is preferred to irradiate ultraviolet rays at the time of bringing the first metal oxide film-forming solution into contact with the substrate. It appears that by the irradiation of the ultraviolet rays, a reaction corresponding to the electrolysis of water can be induced. Thus, the generated hydroxide ions make the pH of the first metal oxide film-forming solution high so that an environment where the first metal oxide film is easily formed can be generated. Furthermore, by the irradiation of the ultraviolet rays, the crystallinity of the obtained first metal oxide film can be improved.

In the present invention, it is preferable to spray the second metal oxide film forming-solution to bring the solution into contact with the substrate having the first metal oxide film. When the second metal oxide film forming-solution is sprayed, the second metal oxide film forming-solution can be brought into contact, without lowering the temperature of the substrate having the first metal oxide film, therewith.

Furthermore, in the present invention, the second metal oxide film forming-solution preferably comprises at least one of an oxidizing agent and a reducing agent. When the second metal oxide film forming-solution comprises at least one of the oxidizing agent and the reducing agent, a metal oxide film can be obtained at a lower substrate-heating temperature than in conventional spray pyrolysis deposition methods. Moreover, in the invention, the use of a combination of the oxidizing agent with the reducing agent also makes it possible to yield a metal oxide film at a low substrate-heating temperature.

In the present invention, the second metal oxide film forming-solution preferably comprises hydrogen peroxide or sodium nitrite as the oxidizing agent. This makes it possible to lower the temperature for heating the substrate having the first metal oxide film to yield a metal oxide film at a lower substrate-heating temperature than in conventional spray pyrolysis deposition methods.

In the present invention, the second metal oxide film forming-solution preferably comprises a borane-based complex as the reducing agent. This makes it possible to lower the temperature for heating the substrate having the first metal oxide film to yield a metal oxide film at a lower substrate-heating temperature than in conventional spray pyrolysis deposition methods.

Further in the present invention, the metal source used in the first metal oxide film-forming solution preferably comprises at least one metal element selected from the group consisting of Mg, Al, Si, Ca, Ti, V, Mn, Fe, Co, Ni, Cu, Zn, Y, Zr, Ag, In, Sn, Ce, Sm, Pb, La, Hf, Sc, Gd, and Ta. The metal elements each have a metal oxide region or a metal hydroxide region in the Pourbaix diagram thereof; therefore, the elements are each suitable as a main constituting element of the first metal oxide film.

Moreover in the present invention, the metal source used in the second metal oxide film-forming solution preferably comprises at least one metal element selected from the group consisting of Mg, Al, Si, Ca, Ti, V, Mn, Fe, Co, Ni, Cu, Zn, Y, Zr, Ag, In, Sn, Ce, Sm, Pb, La, Hf, Sc, Gd, Ta, Cr, Ga, Sr, Nb, Mo, Pd, Sb, Te, Ba and W. The metal elements can each give a stable metal oxide film. Thus, the elements are each suitable as a main constituting element of the second metal oxide film.

In the present invention, at least one of the first metal oxide film-forming solution and the second metal oxide film-forming solution preferably comprises at least one ion species selected from the group consisting of a chlorate ion, a perchlorate ion, a chlorite ion, a hypochlorite ion, a bromate ion, a hypobromate ion, a nitrate ion, and a nitrite ion. The ions species each react with electrons, whereby hydroxide ions can be generated, to make the pH of the metal oxide film-forming solution high. As a result, an environment where the metal oxide film is easily formed can be generated.

Still furthermore, it is preferable in the invention that the second metal oxide film forming-solution further comprises a ceramic fine particle. The use of the ceramic fine particle makes it possible to form a metal oxide film to surround the ceramic fine particle. As a result, it is possible to yield a mixed film made of different ceramics, or increase the volume of the metal oxide film.

Effects of the Invention

The invention produces an advantageous effect that an even and dense metal oxide film having a sufficient film thickness can be given onto a substrate such as a substrate having a complicated structural part or a substrate made of a porous material.

### BEST MODE FOR CARRYING OUT THE INVENTION

Hereinafter, the method of the invention for producing a metal oxide film will be described in detail.

The method of producing a metal oxide film of the present invention comprises: a first metal oxide film-forming step of bringing a substrate into contact with a first metal oxide film forming-solution that has a metal salt or a metal complex as a metal source and at least one of an oxidizing agent and a reducing agent dissolved, and forming a first metal oxide film on the substrate; and a second metal oxide film-forming step of heating the substrate having the first metal oxide film up to a metal oxide film forming-temperature or higher, bringing the resultant into contact with a second metal oxide film forming-solution that has a metal salt or a metal complex dissolved as a metal source, and yielding a second metal oxide film.

In the invention, an even and dense electroconductive film having a sufficient film thickness can be given to, for example, a substrate made of a porous material. Specifically, a dense ITO transparent electroconductive film can be given to a substrate having, on its surface, porous titanium oxide.

Further for example, in the invention, nonmetallic properties can be given to a metallic substrate subjected to microfabrication by the etching technique. Specifically, insulation properties can be given. The invention can be used at a higher temperature than any conventional insulating methods using a resin. The metal oxide film produced by this method is excellent in adhesive properties to a metallic substrate, and is dense. Consequently, while in the conventional insulating method using a resin, a film thickness of about 10 μm is required, the present invention enables to gain equivalent insulating properties even when a metal oxide film has a film thickness of about 1 μm.

In invention, for example, corrosion resistance can be given to a metallic substrate subjected to microfabrication by the etching technique. Specifically, when a metal oxide film that is strong in acid or alkali and has electroconductivity is formed, a member that can be used in an environment where a single use of metal could not meet the purpose can be obtained. Furthermore, in the invention, a colored metal oxide film having corrosion resistance as described above can be obtained. Accordingly, the film can be used in a member for which designability is be desired, specifically a member for resisting acid rain in buildings or plants, or the like.

The invention can be used in a resin substrate subjected to microfabrication, or in other members. By use of the invention, it is possible to subject an inexpensive resin, which is easily processed, for microfabrication and to provide organic solvent resistance, hydrophilicity or living body affinity thereto. Accordingly, the invention can be used in organic solvent plants, organic solvent containers, biochips, or general physical and chemical appliances.

Next, the method of the invention for producing a metal oxide film is described by using the drawings. As illustrated in, for example, FIGS. 1A to 1D, in a first metal oxide film-forming step, a substrate 1 is immersed in a first metal oxide film forming-solution 2 so as to be brought into contact with the solution 2 (FIG. 1A), and a first metal oxide film 3 is formed on the substrate 1 (FIG. 1B). Subsequently, in a second metal oxide film-forming step, the substrate 1 having the first metal oxide film 3 is heated up to a metal oxide film forming-temperature or higher, and a second metal oxide film forming-solution 4 is sprayed thereto by a spraying device 5, so as to be brought into contact therewith (FIG. 1C) , thereby forming a second metal oxide film on the first metal oxide film. As a result, a dense metal oxide film 6 is yielded.

Next, a change in the valence of the metal sources in the metal oxide film producing method of the invention is described, using a case in which a cerium oxide (CeO₂) film is yielded from first and second metal oxide film forming-solutions which each contain cerium ions Ce³⁺ as the metal source thereof. In the invention, cerium oxide (CeO₂) is formed from a metal oxide film forming-solution which contains cerium ions Ce³⁺ in each of the first metal oxide film-forming step and the second metal oxide film-forming step. FIG. 2 is the Pourbaix diagram of cerium. In the invention, cerium present in the form of Ce³⁺ (corresponding to a Ce³⁺ region in the diagram) in the metal oxide film forming-solution changes in the valence thereof, so that the cerium turns to a CeO₂ film (corresponding to a CeO₂ region in the diagram). In other words, it can be considered that cerium ions are transited from the Ce³⁺ region in the diagram to the CeO₂ region in the diagram by heat or some other effect. It can also be considered that similarly to the heating, the oxidizing agent, the reducing agent, the oxidized gas, the ultraviolet rays and others that are preferably used in the invention make cerium ions in the Ce³⁺ region into a state that the cerium ions approach the CeO₂ region more easily. From this matter, it appears that the producing method of the invention makes it possible that a metal element having a similar metal oxide region gives a metal oxide film in the same manner. Even a metal element having a metal hydroxide region can give a metal oxide film by heating a film of the metal hydroxide.

The effect of the reducing agent used in the invention is described with a reference to a case of using the following in the first metal oxide film-forming step in the invention so as to form a cerium oxide (CeO₂) film: cerium nitrate (Ce (NO₃)₃) as a metal source, a borane-dimethylamine complex (alias: dimethylborane, DMAB) asareducing agent, and water as a solvent.

Although the mechanism is not made completely clear, it appears that the cerium oxide film is formed in accordance with the following six formulae:
(i) Ce(NO₃)₃→Ce³⁺+3NO₃⁻
(ii) (CH₃)₂NHBH₃+2H₂O→BO₂⁻+(CH₃)₂NH+7H⁺+6e⁻
(iii) 2H₂O+2e⁻→2OH⁻+H₂
(iv) Ce³⁺→Ce⁴⁺e⁻
(v) Ce⁴⁺+2OH⁻→Ce(OH)₂²⁺
(vi) Ce(OH)₂²⁺→CeO₂+H₂

At this time, cerium nitrate turns to cerium ions in the aqueous solution (formula (i)}. Subsequently, the reducing agent DMAB decomposes (formula (ii)) to release electrons. Thereafter, the released electrons induce the electrolysis of water (formula (iii)) to generate hydroxide ions, thereby making the pH of the metal oxide film-forming solution high. As a result, the valence of the cerium ions is changed (formula (iv) , and the cerium ions react with the generated hydroxide ions (formula (v)), so that Ce(OH)₂²⁺ is generated. Thereafter, Ce(OH)₂²⁺ near the substrate turns to CeO₂ by the local rise in the pH (formula (vi)). The reactions (ii) to (vi) are repeated, thereby forming a cerium oxide film.

The effect of the oxidizing agent used in the invention is described with a reference to a case of using the following in the first metal oxide film-forming step so as to form a cerium oxide (CeO₂) film in the same manner as in the case of the reducing agent: cerium nitrate (Ce(NO₃)₃) as a metal source, sodium chlorate (NaClO₃) as an oxidizing agent, and water as a solvent.

Although the mechanism is not made completely clear, it appears that the cerium oxide is formed in accordance with the following three formulae:
(vii) Ce(NO₃)₃→Ce³⁺+3NO₃⁻
(viii) 2Ce³⁺+ClO₃⁻→2Ce⁴⁺+ClO₂⁻
(ix) Ce⁴⁺+2H₂O→CeO₂+4H⁺

At this time, cerium nitrate turns to a cerium ion in the aqueous solution (formula (vii) Subsequently, a chlorate ion (ClO₃⁻) generated by the dissolution of the oxidizing agent (NaClO₃) causes the valence of the cerium ion to be changed (formula (viii). Generated Ce⁴⁺ reacts with water to turn to CeO₂ (formula (ix)). The reactions (vii) to (ix) are repeated, thereby forming a cerium oxide film. Generated Ce⁴⁺ in the formula (viii) can be present only in the formof CeO₂ or Ce(OH)₂²⁺ in the Pourbaix diagram. Thus, in the invention, at the stage when Ce⁴⁺ is generated, the ion would immediately precipitate in the form of CeO₂.

In the case of using, as the solvent, not water but an alcohol, an organic solvent or the like in the invention, it can be considered that a metal oxide film is generated by a reaction similar to the above-mentioned reaction or a very small amount of water contained in the solvent.

About the metal oxide film producing method of the invention, each of the first metal oxide film-forming step and the second metal oxide film-forming step will be described in detail hereinafter.

A. First Metal Oxide Film-Forming Step

The first metal oxide film-forming step in the invention is a step of bringing a substrate into contact with a first metal oxide film forming-solution that has a metal salt or a metal complex as a metal source and at least one of an oxidizing agent and a reducing agent dissolved, thereby forming a first metal oxide film on the substrate.

The present step is based on a wet coating using the first metal oxide film forming-solution; thus, even if the substrate has, a complicated structural part, the above-mentioned solution can invade the inside of the structural part with ease. Accordingly, a first metal oxide film can be yielded in the structural part or on the surface thereof. Furthermore, the oxidizing agent and/or the reducing agent contained in the first metal oxide film forming-solution can produce an environment where the first metal oxide film is easily formed. The first metal oxide film forming-solution and others that are used in the step will be described in detail hereinafter.

1. First Metal Oxide Film Forming-Solution

First, the metal oxide film forming-solution used in the metal oxide film producing method of the invention is described. The first metal oxide film forming-solution used in the invention is a solution containing at least an oxidizing agent and/or a reducing agent, a metal salt or metal complex which is a metal source, and a solvent.

(1) Oxidizing Agent

The oxidizing agent used in the first metal oxide film forming-solution in the invention is an agent having a function of promoting the oxidization of a metal ion or the like that is obtained by the dissolution of the metal source which will be detailed later. When the valence of the metal ion or the like is varied, an environment where the first metal oxide film is easily formed can be produced.

The concentration of the oxidizing agent in the first metal oxide film forming-solution used in the invention is varied in accordance with the kind of the oxidizing agent, and is usually from 0.001 to 1 mol/L. In particular, the concentration is preferably from 0.01 to 0.1 mol/L. If the concentration is below the range, the first metal oxide film may not be formed. If the concentration is over the range, a large difference in produced advantageous effects is not observed. Thus, such a case is unfavorable from the viewpoint of costs.

This oxidizing agent is not particularly limited as long as the agent is dissolved in the solvent, which will be detailed later, and makes it possible to promote the oxidization of the metal source. Examples thereof include hydrogen peroxide, sodium nitrite, potassium nitrite, sodium bromate, potassium bromate, silver oxide, dichromic acid, and potassium permanganate. In particular, the use of hydrogen peroxide and sodium nitrite is preferred.

(2) Reducing Agent

The reducing agent used in the first metal oxide film forming-solution of the invention is an agent having a function of releasing electrons by the decomposition reaction and generating hydroxide ions by the decomposition reaction of water, thereby making the pH of the first metal oxide film-forming solution high. The pH is made high to lead the system into the metal oxide region or the metal hydroxide region in the Pourbaix diagram, thereby producing an environment where the first metal oxide film is easily generated.

The concentration of the reducing agent in the first metal oxide film-forming solution used in the invention is usually from 0.001 to 1 mol/L, in particular preferably from 0.01 to 0.1 mol/L. If the concentration is below the range, the first metal oxide film may not be formed. If the concentration is over the range, obtained advantageous effects do not have a large difference. Thus, such a case is not favorable from the viewpoint of costs.

This reducing agent is not particularly limited as long as the agent is dissolved in a solvent detailed later and can release electrons by the decomposition reaction. Examples include boron based complexes such as a boron-tert-butylamine complex, aboron-N,Ndiethylaniline complex, a bron-dimethylamine complex and a boron-trimethylamine complex, sodium cyanoborohydride, and sodium borohydride. It is particularly preferred to use a boron based complex.

In the step, the first metal oxide film can be also formed by using a combination of the reducing agent with the above-mentioned oxidizing agent. The combination of the reducing agent with the oxidizing agent is not particularly limited, and examples thereof include a combination of hydrogen peroxide or sodium nitrite with any reducing agent, and a combination of any oxidizing agent with a borane based complex. In particular, the combination of hydrogen peroxide with a borane based complex is preferred.

(3) Metal Source

The metal source used in the first metal oxide film forming-solution of the invention may be a metal salt or a metal complex as long as the source is dissolved in the first metal oxide film-forming solution to provide a first metal oxide film by actions of the above-mentioned oxidizing agent, reducing agent, and the like. The “metal complex” in the invention includes, in the category thereof, a product where an inorganic or organic material is coordinated to a metal ion, or the so-called organometallic compound, which has a metal-carbon bond in the molecule.

The concentration of the metal source in the first metal oxide film-forming solution used in the invention is as follows: when the metal source is a metal salt, it is usually from 0.001 to 1 mol/L, in particular preferably from 0.01 to 0.1 mol/L; and when the metal source is a metal complex, it is usually from 0.001 to 1 mol/L, in particular preferably from 0.01 to 0.1 mol/L. If the concentration is below the range, the first metal oxide film is not sufficiently formed so that the metal source may not contribute to an improvement in the denseness. If the concentration is over the range, a metal oxide film having an even film thickness may not be obtained.

The metal element which constitutes this metal source is not particularly limited as long as the element can give a desired first metal oxide film. The metal element is preferably selected form the group consisting of, for example, Mg, Al, Si, Ca, Ti, V, Mn, Fe, Co, Ni, Cu, Zn, Y, Zr, Ag, In, Sn, Ce, Sm, Pb, La, Hf, Sc, Gd, and Ta. The metal elements each have a metal oxide region or a metal hydroxide region in the Pourbaix diagram thereof; therefore, the elements are each suitable as a main constituting element of the first metal oxide film.

Specific examples of the above-mentioned metal salt include chlorides, nitrates, sulfates, perchlorates, acetates, phosphates, and bromates which each contain the above-mentioned metal element. In the invention, it is particularly preferred to use a chloride, a nitrate, or an acetate since these compounds are easily available as a widely-used product.

Specific examples of the above-mentioned metal complex include magnesium diethoxide, aluminum acetylacetonate, calcium acetylacetonate dihydrate, calcium di(methoxyethoxide), calcium gluconate monohydrate, calcium citrate tetrahydrate, calcium salicylate dihydrate, titanium lactate, titanium acetylacetonate, tetraisopropyl titanate, tetra-n-butyl titanate, tetra(2-ethylhexyl) titanate, butyl titanate diner, titanium bis(ethylhexoxy)bis(2-ethyl-3-hydroxyhexoxide), diiopropoxytitanium bis(triethanolaminate), dihydroxybis(ammonium lactate) titanium, diisopropoxytitanium bis(ethylacetoacetate), titaniumperoxicitricacid ammonium tetrahydrate, dicyclopentadienyliron (II), iron (II) lactatetrihydrate, iron (III) acetylacetonate, cobalt (II) acetylacetonate, nickel (II) acetylacetonate dihydrate, copper (II) acetylacetonate, copper (II) dipyvaloylmethanate, copper (II) ethylacetoacetate, zinc acetylacetonate, zinc lactate trihydrate, zinc salicylate trihydrate, zinc stearate, strontium dipyvarolylmethanate, yttrium dipyvaroyl methanate, zirconium tetra-n-butoxide, zirconium (IV) ethoxide, zirconium n-propinate, zirconium n-butyrate, zirconium tetraacetylacetonate, zirconium monoacetylacetonate, zirconium acetylacetonate bisethylacetoacetate, zirconium acetate, zirconium monostearate, penta-n-butoxyniobium, pentaethoxyniobium, pentaisopropoxyniobium, indium (III) tris(acetylacetonate), indium (III) 2-ethylhexanoate, tetraethyltin, oxydibutyltin (IV) , tricyclohexyltin (IV) hydroxide, lanthanum acetylacetonate dihydrate, tri(methoxyethoxy)lanthanum, pentaisopropoxytantalum, pentaethoxytantalum, tantalum (V) ethoxide, cerium (III) acetylacetonate n-hydrate, lead (III) citrate trihydrate, and lead cyclohexanebutyrate. In the invention, it is preferred to use the magnesium diethoxide, aluminum acetylacetonate, calcium acetylacetonate dihydrate, titanium lactate, titanium acetylacetonate, tetraisopropyl titanate, tetra-n-butyl titanate, tetra(2-ethylhexyl) titanate, butyl titanate dimer, diisopropoxytitanium bis(ethylacetoacetate), iron (II) lactate trihydrate, iron (III) acetylacetonate, zinc acetylacetonate, zinc lactate trihydrate, strontium dipyvarolylmethanate, pentaethoxyniobium, indium (III) tris(acetylacetonate), indium (III) 2-ethylhexanoate, tetraethyltin, oxydibutyltin (IV), lanthanum acetylacetonate dihydrate, tri (methoxyethoxy) lanthanum, and cerium (III) acetylacetonate n-hydrate.

In the invention, the first metal oxide film-forming solution may contain two or more of the above-mentioned metal elements. The use of plural kinds of the metal elements makes it possible to yield a complex first metal oxide film made of, for example, ITO, Gd-CeO₂, Sm—CeO₂, or Ni—Fe₂O₃.

(4) Solvent

The solvent used in the first metal oxide film forming-solution of the invention is not particularly limited as long as the reducing agent, the metal source mentioned-above can be dissolved therein. When the metal source is a metal salt, examples thereof include water; lower alcohols where the total number of carbon atoms is 5 or less, such as methanol, ethanol, isopropyl alcohol, propanol or butanol; toluene; and mixed solvents thereof. When the metal source is a metal complex, examples thereof include, the above-mentioned lower alcohols, toluene, and mixed solvents thereof. In the present step, the above-mentioned solvents may be combined for use. In the case of using, for example, a metal complex that has a low solubility in water and a high solubility in an organic solvent and a reducing agent that has a low solubility in the organic solvent and a high solubility in water, water is mixed with the organic solvent, thereby dissolving the two in each other. In this way, an even metal oxide film-forming solution can be prepared.

(5) Additives

The first metal oxide film-forming solution used in the invention may contain additives such as an auxiliary ion source, and a surfactant.

The auxiliary ion source is a source which reacts with electrons to generate hydroxyl ions. The source makes it possible to make the pH of the first metal oxide film-forming solution high, thereby generating an environment where a metal oxide film is easily formed. It is preferred to select the use amount of the auxiliary ion source appropriately in accordance with the used metal source and reducing agent.

A specific example of the auxiliary ion source is an ion species selected from the group consisting of a chlorate ion, a perchlorate ion, a chlorite ion, a hypochlorite ion, bromate ion, a hypobromate ion, a nitrate ion, and a nitrite ion. These auxiliary ion sources would cause the following reactions in the solution:
ClO₄⁻+H₂O+2e⁻ [symbol] ClO₃⁻+2OH⁻
ClO₃⁻+H₂O+2e⁻ [symbol] ClO₂⁻+2OH⁻
ClO₂⁻+H₂O+2e⁻ [symbol] ClO⁻+2OH⁻
2ClO⁻+2H₂O+2e⁻ [symbol] Cl₂ (g)+4OH⁻
BrO₃⁻+2H₂O+4e⁻ [symbol] BrO⁻+4OH⁻
2BrO⁻+2H₂O+2e⁻ [symbol] Br₂+4OH⁻
NO₃⁻+H₂O+2e⁻ [symbol] NO₂⁻+2OH⁻
NO₂⁻+3H₂O+3e⁻ [symbol] NH₃+3OH⁻

The above-mentioned surfactant is an agent having a function of acting onto the interface between the first metal oxide film-forming solution and the substrate surface to make the formation of a metal oxide film on the substrate surface easy. It is preferred to select the use amount of the surfactant appropriately in accordance with the used metal source and reducing agent.

Examples of the surfactant include SURFYNOL series, such as SURFYNOL 485, SURFYNOL SE, SURFYNOL SE-F, SURFYNOL 504, SURFYNOL GA, SURFYNOL 104A, SURFYNOL 104BC, SURFYNOL 104PPM, SURFYNOL 104E, and SURFYNOL 104PA, which are each manufactured by Nissin Chemical Industry Co., Ltd.; and NIKKOL AM301, and NIKKOL AM3130N, which are each manufactured by Nikko Chemicals Co., Ltd.

2. First Metal Oxide Film

Next, the first metal oxide film formed in the present step is described. In the invention, the first metal oxide film is a film formed by bringing the first metal oxide film forming-solution and the substrate into contact with each other.

The first metal oxide film carried on the substrate is not particularly limited as long as the film permits a metal oxide film having a desired denseness to be yielded in the second metal oxide film-forming step which will be detailed later. The first metal oxide film may be, for example, a metal oxide film covering the substrate completely, or one may partially cover the substrate. Examples of the first metal oxide film covering the substrate partially include a case where the film is present in a sea-island form in a porous substrate, and a case where the film is present in a pattern form on a smooth substrate surface.

The first metal oxide film is preferably near to the metal oxide film which constitutes the second metal oxide film in crystal system. In particular, the first metal oxide film is more preferably a metal oxide film containing a main element which constitutes the second metal oxide film.

3. Substrate

Next, the substrate used in the metal oxide film producing method of the invention is described. The material of the substrate used in the invention is not particularly limited as long as the material has heat resistance against the heating temperature in the second metal oxide film-forming step, which will be detailed later. Examples thereof include glass, SUS, metal plates, ceramic substrates, and heat resistant plastics. In particular, glass, SUS, a metal plate or a ceramic substrate is preferably used since the material has versatility and sufficient heat resistance.

The material of the substrate used in the invention is not particularly limited, and maybe as follows: an object having a flat and smooth surface, an object having a microscopic structural part, an object in which a hole is made, an object in which a groove is made, an object in which a flow channel is present, or a porous object. In the invention, particularly preferred is a substrate having a structural part such as a substrate having a complicated microscopic structure, a porous substrate, or a substrate having a porous film. This is because the first metal oxide film-forming solution can invade the inside of the substrate, form a first metal oxide film and undergoing the second metal oxide film-forming step so that a dense metal oxide film having good shape-following properties can be produced.

4. Manner of Bringing the Substrate and the First Metal Oxide Film-Forming Solution into Contact with each Other

Next, the manner in the present step of bringing the substrate and the first metal oxide film-forming solution into contact with each other is described. The contacting manner in the invention is not particularly limited as long as the above-mentioned substrate and first metal oxide film-forming solution can be caused to contact each other. Specific examples of the manner include a roll coating manner, a dipping manner, a sheet-forming manner, and a manner of coating the solution made into a mist form.

The roll coating manner is a manner as illustrated in, for example, FIG. 3, where a substrate 1 is caused to pass between a roll 7 and a roll 8 to form a first metal oxide film onto a substrate 1 , and is suitable for continuously producing a metal oxide film. The dipping manner is a method of immersing the substrate into the first metal oxide film-forming solution, thereby forming a first metal oxide films onto the substrate. As illustrated in, for example, FIG. 4A, the whole of a substrate 1 is immersed into a first metal oxide film-forming solution 2, thereby forming first metal oxide film onto the whole surface of the substrate 1. When shielding portions are formed on the surface of the substrate 1, patterned first metal oxide film can be formed on the surface of the substrate 1, which is not illustrated in FIG. 4A. As illustrated in, for example, FIG. 4B, the first metal oxide film-forming solution 2 is caused to flow at a constant flow rate so as to be brought into contact with only the inner face of the substrate 1, thereby making it possible to form a first metal oxide film onto the inner face only. The sheet-forming manner is a manner as illustrated in, for example, FIG. 5, where a first metal oxide film-forming solution 2 is circulated by means of a pump 9 to heat only a substrate 1, thereby promoting the first metal oxide film forming reaction near a surface of the substrate to form a first metal oxide film on the substrate.

In the present step, at the time of bringing the above-mentioned substrate into contact with the above-mentioned first metal oxide film-forming solution, an oxidized gas is mixed therewith, ultraviolet rays are irradiated thereon, the two are heated, or these manners are combined with each other, whereby the film-forming speed of the first metal oxide film can be improved. These manners will be described hereinafter.

(1) Improvement on the Film-Forming Speed by the Mixing of an Oxidized Gas

In the present step, it is preferred that at the time of bringing the substrate and the first metal oxide film-forming solution into contact with each other, an oxidized gas is mixed therewith.

This oxidized gas is not particularly limited as long as the gas is a gas having oxidizing capability and making it possible to improve the film-forming speed of the first metal oxide film. Examples include oxygen, ozone, nitrogen peroxide, nitrogen dioxide, chlorine dioxide, and halogen gases. It is preferred to use oxygen and ozone out of these gases, and particularly preferred to use ozone since ozone is industrially widely available so that costs can be reduced.

The manner of mixing the oxidized gas is not particularly limited. When using the above-mentioned immersing manner the manner is a manner of bringing the oxidized gas in an air bubble form into contact with the contact region of the substrate and the first metal oxide film-forming solution. The introduction of the air-bubble form oxidized gas is not particularly limited, and, a manner of using a bubbler can be cited as an example. The use of the bubbler makes it possible to increase the contact area between the oxidized gas and the solution to effectively improve the film-forming speed of the first metal oxide film. As this bubbler, common bubblers can be used, and a Naflon Bubbler [transliteration] (manufactured by AS ONE CORPORATION) can be cited as an example. Usually, the oxidized gas can be supplied from a gas cylinder. Regarding ozone, it can be supplied from an ozone generating device to the first metal oxide film-forming solution.

(2) Improvement on the Film-Forming Speed by the Irradiation of Ultraviolet Rays

In the present step, it is also preferred that at the time of bringing the substrate and the first metal oxide film-forming solution into contact with each other, ultraviolet rays are irradiated thereto. The irradiation of the ultraviolet rays would make it possible to induce a reaction corresponding to the electrolysis of water or promote the decomposition of the reducing agent. As a result, the generated hydroxide ions cause a rise in the pH of the first metal oxide film-forming solution so that an environment where the first metal oxide film is easily formed can be generated. Moreover, the irradiation of the ultraviolet rays makes it possible to generate hydroxide ions from the auxiliary ion source, and further improve the crystallinity of the resultant first metal oxide film.

The manner of irradiating the ultraviolet rays in the preset step is not particularly limited as long as it is a manner of irradiating ultraviolet rays to the contact region of the substrate and the first metal oxide film-forming solution. In the case of using, for example, the above-mentioned immersing manner, the manner is a manner as illustrated in FIG. 6, in which a substrate 1 is immersed into a first metal oxide film-forming solution 2, and ultraviolet rays 10 are irradiated thereto from the side of the solution. In this case, the thickness of the first metal oxide film-forming solution, present on the substrate surface onto which the ultraviolet rays are irradiated, is preferably thin so that the ultraviolet rays can be irradiated precisely onto the contact region of the substrate and the first metal oxide film-forming solution.

The wavelength of the ultraviolet rays is usually from 185 to 470 nm, in particular preferably from 185 to 260 nm. The intensity of the ultraviolet rays used in the embodiment is usually from 1 to 20 mW/cm², in particular preferably from 5 to 15 mW/cm².

As an ultraviolet ray radiating device for conducting the ultraviolet ray irradiation, there can be used a UV light irradiating device, a laser emitting device or the like that is commercially available. An example thereof is an HB400X-21 manufactured by SEN LIGHTS CORPORATIONORATION.

(3) Improvement on the Film-Forming Speed by Heating

In the present step, it is also preferred that at the time of bringing the substrate and the first metal oxide film-forming solution into contact with each other, they are heated. The heating makes it possible to improve the film-forming speed of the first metal oxide film. The manner for the heating is not particularly limited as long as the manner can cause an improvement in the film-forming speed of the first metal oxide film. It is preferred to heat the substrate, and it is particularly preferred to heat the substrate and the first metal oxide film-forming solution since the film-forming reaction of the first metal oxide film can be promoted near the substrate.

Preferably, the temperature for the heating is appropriately selected in accordance with features of such as the first metal oxide film-forming solution to be used. Specifically, the temperature ranges preferably from 50 to 150° C., more preferably from 70 to 100° C.

B. Second Metal Oxide Film-Forming Step

The second metal oxide film-forming step in the invention is a step of heating the substrate having the first metal oxide film up to a metal oxide film forming-temperature or higher and bringing the resultant into contact with a second metal oxide film forming-solution in which a metal salt or metal complex is dissolved as a metal source, thereby yielding a second metal oxide film. In the invention, the “metal oxide film forming-temperature” is a temperature at which the metal element which constitutes the metal source contained in the second metal oxide film forming-solution bonds to oxygen so that a metal oxide film can be formed on the substrate. The temperature is largely varied in accordance with the kind of the metal source of the metal salt or metal complex, and the composition of the second metal oxide film forming-solution, which is made of a solvent and so on. In the invention, this “metal oxide film forming-temperature” can be measured by the following method. The second metal oxide film forming-solution actually containing a desired metal source is prepared, and the solution is brought into contact with the substrate while the temperature for heating the substrate is varied. In this way, the lowest substrate heating temperature that enables to form the metal oxide film is measured. This lowest substrate heating temperature can be defined as the “metal oxide film forming-temperature” in the invention. Whether or not the metal oxide film is formed at this time is determined from results obtained through an X-ray diffraction meter (RINT-1500, manufactured by Rigaku Corporation). In the case that the film is an amorphous film, which does not have crystallinity, it is determined from results obtained through a photoelectron spectral analyzer (ESCALAB 200i-XL), manufactured by V. G. Scientific Ltd.).

In the present step, the substrate having the first metal oxide film is heated up to the metal oxide film forming-temperature or higher, and the resultant is brought into contact with a second metal oxide film forming-solution, thereby making it possible to form a second metal oxide film on the first metal oxide film. As a result, an even and dense metal oxide film having a sufficient film thickness can be yielded.

Hereinafter, about the step, each of constituents will be described in detail.

1. Second Metal Oxide Film Forming-Solution

First, the second metal oxide film forming-solution used in the metal oxide film producing method of the invention is described. The second metal oxide film forming-solution used in the invention is a solution containing at least a metal salt or metal complex as a metal source, and a solvent.

In the invention, it is preferred that the second metal oxide film forming-solution contains at least one of an oxidizing agent and a reducing agent. When at least one of the oxidizing agent and the reducing agent is incorporated thereto, the second metal oxide film can be yielded at a lower substrate heating temperature than in the spray pyrolysis deposition method in the prior art. Hereinafter, the constituents of this second metal oxide film forming-solution will be described.

(1) Metal Source

The metal source used in the second metal oxide film forming-solution in the invention is a substance which is dissolved in the second metal oxide film forming-solution and gives a second metal oxide film on the substrate having the first metal oxide film. The metal source may be a metal salt or metal complex as long as the source is dissolved in the solvent which will be detailed later.

The concentration of the metal source in the second metal oxide film-forming solution used in the invention is as follows: when the metal source is a metal salt, it is usually from 0.001 to 1 mol/L, in particular preferably from 0.01 to 0.5 mol/L; and when the metal source is a metal complex, it is usually from 0.001 to 1 mol/L, in particular preferably from 0.01 to 0.5 mol/L. If the concentration is below the range, the second metal oxide film formation on the substrate may take too much time and it is not suitable for industrial production. If the concentration is over the range, a second metal oxide film having an even film thickness may not be obtained.

The metal element which constitutes this metal source is not particularly limited as long as the element can give a desired second metal oxide film. The metal element is preferably selected form the group consisting of, for example, Mg, Al, Si, Ca, Ti, V, Mn, Fe, Co, Ni, Cu, Zn, Y, Zr, Ag, In, Sn, Ce, Sm, Pb, La, Hf, Sc, Gd, Ta, Cr, Ca, Sr, Nb, Mo, Pd, Sb, Te, Ba and W. These metal elements are each suitable as a main constituting element of a second metal oxide film since they can produce a stable metal oxide film.

Specific examples of the above-mentioned metal salt include chlorides, nitrates, sulfates, perchlorates, acetates, phosphates, and bromates which each contain the above-mentioned metal element. In the invention, it is particularly preferred to use such as a chloride, a nitrate, or an acetate since these compounds are easily available as widely-used products.

Specific examples of the metal complex include the metal complexes listed up in connection with the above-mentioned first metal oxide film forming-solution, and further include calcium acetylacetonate dihydrate, chromium (III) acetylacetonate, gallium (III) trifluoromethanesulfonate, strontium dipivaloyl methanate, niobium pentachloride, molybdenum acetylacetonate, palladium (II) acetylacetonate, antimony (III) chloride, and sodium tellurate, barium chloride dihydrate, and tungsten (VI) chloride.

In the invention, the second metal oxide film-forming solution may contain two or more of the above-mentioned metal elements. The use of two or more of the metal elements makes it possible to yield a complex second metal oxide film made of, for example, ITO, Cd—CeO₂, Sm—CeO₂, or Ni—Fe₂O₃.

(2) Oxidizing Agent

The oxidizing agent used in the second metal oxide film forming-solution in the invention is an agent having a function of promoting the oxidization of a metal ion or the like that is obtained by the dissolution of the metal source mentioned above. When the valence of the metal ion or the like is varied, an environment where the second metal oxide film is easily formed can be produced and the second metal oxide film can be yielded at a lower substrate heating temperature than in the spray pyrolysis deposition method in the prior art.

The concentration of the oxidizing agent in the second metal oxide film forming-solution used in the invention is varied in accordance with the kind of the oxidizing agent, and is usually from 0.001 to 1 mol/L. In particular, the concentration is preferably from 0.01 to 0.1 mol/L. If the concentration is below the range, the effect of lowering the substrate heating temperature may not be realized. If the concentration is over the range, a large difference in produced advantageous effects is not observed. Thus, such a case is unfavorable from the viewpoint of costs. Specific examples of such oxidizing agent are same as those mentioned in the section of “A. First metal oxide film-forming step”. Thus, explanation is omitted.

(3) Reducing Agent

The reducing agent used in the second metal oxide film forming-solution of the invention is an agent having a function of releasing electrons by the electrolysis and generating hydroxide ions by the decomposition reaction of water, thereby making the pH of the second metal oxide film-forming solution high. The pH is made high to lead the system into the metal oxide region or the metal hydroxide region in the Pourbaix diagram, thereby producing an environment where a metal oxide film is easily generated and the second metal oxide film can be yielded at a lower substrate heating temperature than in the spray pyrolysis deposition method in the prior art.

The concentration of the reducing agent in the second metal oxide film-forming solution used in the invention is varied in accordance with the kind of the reducingagent. It is usually from 0.001 to 1 mol/L, in particular preferably from 0.01 to 0.1 mol/L. If the concentration is below the range, the effect of lowering the substrate heating temperature may not be realized. If the concentration is over the range, obtained advantageous effects do not have a large difference. Thus, such a case is not favorable from the viewpoint of costs. Specific examples of such reducing agent are same as those mentioned in the section of “A. First metal oxide film-forming step”. Thus, explanation is omitted.

In the present invention, the second metal oxide film can be also formed at a lower substrate heating temperature than in the spray pyrolysis deposition method in the prior art, even when a combination of the reducing agent with the oxidizing agent is used. The combination of the reducing agent with the oxidizing agent is not particularly limited as long as it can lower the substrate heating temperature, and examples thereof include a combination of hydrogen peroxide or sodium nitrite with any reducing agent, and a combination of any oxidizing agent with a borane based complex. In particular, the combination of hydrogen peroxide with a borane based complex is preferred.

(4) Solvent

The solvent used in the second metal oxide film forming-solution of the invention is not particularly limited as long as the above-mentioned metal source and the like can be dissolved therein. Specific examples of such solvents are same as those mentioned in the section of “A. First metal oxide film-forming step”. Thus, explanation is omitted.

(5) Additives

The second metal oxide film forming-solution used in the invention may contain additives such as ceramic fine particles, an auxiliary ion source, and a surfactant.

When the ceramic fine particles are contained in the second metal oxide film forming-solution, the second metal oxide film is formed to surround the ceramic fine particles. As a result, a mixed film of different ceramics can be formed or the volume of the metal oxide film can be increased. It is preferred to select the content by percentage of the ceramic fine particles appropriately in accordance with characteristics of a member to be used.

The ceramic fine particles are not particularly limited as long as the particles make it possible to attain the above-mentioned purpose. Examples thereof include ITO, aluminum oxide, zirconium oxide, silicon oxide, titanium oxide, tin oxide, cerium oxide, calcium oxide, manganese oxide, magnesium oxide, and barium titanate.

The auxiliary ion source and the surfactant are the same as described in “A. First metal oxide film-forming step”; thus, the description is omitted.

2. Second Metal Oxide Film

Next, the metal oxide film in the invention is described. The metal oxide film in the invention is obtained in the present step by bringing the second metal oxide film forming-solution into contact with the substrate which is heated up to the metal oxide film forming-temperature and has the first metal oxide film. When the second metal oxide film is formed on the first metal oxide film, an even and dense metal oxide film having a sufficient film thickness can be yielded.

The combination of the first metal oxide film with the second metal oxide film is not particularly limited in the invention as long as a metal oxide film having a desired denseness can be obtained. In particular, a combination of films made of metal oxides having crystal systems near to each other is preferred, and a combination of metal oxide films which each contain a common metal element is more preferred.

When the second metal oxide film is rendered, for example, an ITO film, the first metal oxide film is not particularly limited as long as this film permits a dense ITO film to be formed as the second metal oxide film. Examples thereof include ZnO, ZrO₂, Al₂O₃, Y₂O₃, Fe₂O₃, Ga₂O₃, La₂O₃, Sb₂O₃, ITO, In₂O₃, and SnO₂. In particular, Al₂O₃, Y₂O₃, Fe₂O₃, Ga₂O₃, La₂O₃, Sb₂O₃, ITO, In₂O₃, and SnO₂ are preferred since the crystal system thereof is near to that of the metal oxide film (ITO film) . In particular, ITO, In₂O₃, and SnO₂ are more preferred since the metal elements (In and Sn) which constitute the metal oxide film (ITO film) may become common.

3. Method of bringing the Substrate having the First Metal Oxide Film into Contact with the Second Metal Oxide Film Forming-Solution

Next, the method of bringing the substrate having the first metal oxide film into contact with the second metal oxide film forming-solution in the present step is described. The contact method in the step is not particularly limited as long as the method is a method of bringing the above-mentioned substrate into contact with the above-mentioned second metal oxide film forming-solution. The method is preferably a method of not lowering the temperature of the substrate when the substrate is brought into contact with the second metal oxide film forming-solution. If the substrate temperature lowers, a film-forming reaction is not caused so that a desired second metal oxide film may not be yielded. This method of not lowering the substrate temperature is, for example, a method of making the second metal oxide film forming-solution into droplets and bringing the droplets into contact with the substrate. In particular, the diameter of the droplets is preferably small. When the diameter of the droplets is small, the solvent in the second metal oxide film forming-solution evaporates instantaneously so that a fall in the substrate temperature can be further restrained. Furthermore, an even metal oxide film can be obtained since the droplet diameter is small.

The method of bringing such small-diameter droplets of the metal oxide film forming-solution into contact with the substrate is not particularly limited, and specific examples include: a method of spraying the second metal oxide film forming-solution so as to be brought into contact with the substrate, and a method of causing the substrate to pass in a space where the second metal oxide film forming-solution is made into a mist form.

The method of spraying the second metal oxide film forming-solution so as to be brought into contact with the substrate is, for example, a method of using a spraying device to spray the solution. When the spraying device is used to spray the solution, the diameter of the droplets is usually from 0.001 to 1000 μm, preferably from 0.01 to 300 μm, in particular preferably from 0.01 to 100 μm. When the diameter of the droplets is within the range, a fall in the substrate temperature can be restrained so that an even second metal oxide film can be yielded.

The jet gas in the spraying device is not particularly limited as long as the gas does not hinder the second metal oxide film from being formed. Examples include air, nitrogen, argon, helium, and oxygen. Nitrogen, argon, or helium, which is an inert gas, is preferably used. The jet amount of the jet gas is preferably from 0.1 to 50 L/minute, more preferably from 1 to 20 L/minute. The spraying device may be such as follows: a fixed device, a movable device, a device where the solution is sprayed by rotation, or a device where only the solution is sprayed by pressure. As this spraying device, a commonly used spraying device can be used. For example, the following can be used: a hand spray (Spray Gun No. 8012, manufactured by AS ONE CORPORATION), or an Ultrasonic Nebulizer (NE-U17, manufactured by OMRON HEALTHCARE Co., Ltd.).

In the method of causing the substrate to pass into a space where the second metal oxide film forming-solution is made into a mist form, the diameter of the droplets is usually from 0.1 to 300 μm, preferably from 1 to 100 μm. When the diameter of the droplets is within the range, a fall in the substrate temperature can be restrained so that an even second metal oxide film can be yielded.

In the invention, the second metal oxide film forming-solution is brought into contact with the heated substrate, and at this time the substrate is heated up to the “metal oxide film forming-temperature” or higher. This “metal oxide film forming-temperature” depends on the kind of the metal source, and the composition of the second metal oxide film forming-solution, which is made of a solvent and so on. In the case of not adding an oxidizing agent and/or a reducing agent to an upper side first electrode layer forming coating solution, the temperature may be usually in the range of 400 to 1000° C., preferably in the range of 450 to 700° C. On the other hand, in the case of adding an oxidizing agent and/or a reducing agent to the upper side first electrode layer forming solution, the temperature may be usually in the range of 150 to 400° C., preferably in the range of 200 to 400° C.

The method of heating the substrate is not particularly limited, and an example is a heating method based on a hot plate, an oven, a firing furnace, an infrared lamp, or a hot air blower. Particularly preferred is a method making it possible to bring the substrate into contact with the second metal oxide film forming-solution while the substrate temperature is kept at the above-mentioned temperature. Specifically, the use of a hot plate or the like is preferred.

Next, the method of bringing the substrate into contact with the second metal oxide film forming-solution in the invention is specifically described. The above-mentioned method of spraying the second metal oxide film forming-solution so as to be brought into contact with the substrate is, for example, a method of spraying the solution while the substrate is continuously shifted by rollers, a method of spraying the solution on the fixed substrate, or a method of spraying the solution into a flow channel such as a pipe.

The above-mentioned method of spraying the solution while the substrate is continuously shifted by rollers is a method as illustrated in, for example, FIG. 7, in which rollers 11 to 13 heated to a metal oxide film forming-temperature or higher are used to continuously shift a substrate 1 having a first metal oxide film, and a second metal oxide film forming-solution 4 is sprayed through a spraying device 5 to form a metal oxide film. This method has an advantage that a metal oxide film can be continuously formed.

The method of spraying the solution on the fixed substrate is a method as illustrated in, for example, FIG. 1C, in which a substrate 1 having a first metal oxide film 3 is heated up to a metal oxide film forming-temperature or higher, and a spraying device 5 is used to spray a second metal oxide film forming-solution 4 onto this substrate 1 to form a second metal oxide film, thereby yielding a dense metal oxide film.

The above-mentioned method of causing the substrate to pass into a space where the second metal oxide film forming-solution is made into a mist form is a method as illustrated in, for example, FIG. 8, in which a substrate 1 heated to a metal oxide film forming-temperature or higher and having a first metal oxide film is caused to pass into a space where a second metal oxide film forming-solution 4 is made into a mist form to form a second metal oxide film, thereby forming a dense metal oxide film.

C. Others

In the metal oxide film producing method of the invention, the metal oxide film obtained by the above-mentioned contact method or other methods may be washed. The washing of the metal oxide film is performed to remove impurities present on the surface and others of the metal oxide film. The method is, for example, a method of using the solvent used in the metal oxide film forming-solution to wash the metal oxide film.

The invention is not limited to the above-mentioned embodiments. The embodiments are illustrative, and all that has substantially the same structure and produce the same effect and advantages as the technical conception recited in the claims of the invention are included in the technical scope of the invention.

### EXAMPLES

The invention will be specifically described by way of the following examples.

### Example 1

### Formation of a Zirconium Oxide Film on a SUS Substrate Subjected to Microfabrication

In the present example, a zirconium oxide film was formed on a SUS substrate subjected to a microfabrication to provide insulation properties.

In the example, a SUS304 (thickness: 1 mm) subjected to a microfabrication (grooves 100 μm in width, 10 mm in length, and 50 μm in depth) by an etching method was firstly prepared as a substrate.

Next, 5 g of a borane-trimethylamine complex (manufactured by KANTO KAGAKU) as a reducing agent was added to 1000 g of a 0.05 mol/L solution of oxyzirconium nitrate dehydrate (manufactured by KANTO KAGAKU) in water to yield a first metal oxide film forming-solution.

Next, the first metal oxide film-forming solution was heated up to a temperature of 80° C., and a Naflon Bubbler (manufactured by AS ONE CORPORATION) was used to generate air bubbles at a constant temperature of 80° C. At this time, the first metal oxide film-forming solution was circulated and caused to pass through a filter to remove a precipitation and mixed dusts.

Next, the substrate was subjected to ultrasonic-washing with a neutral detergent, and further immersed in a 30% solution of nitric acid and hydrochloric acid (in equal proportions) in water for 3 minutes. The thus-prepared substrate was immersed in the first metal oxide film forming-solution for 1 hour to yield a first metal oxide film on the substrate.

The first metal oxide film yielded by the above-mentioned method was washed with pure water, and observed by the naked eye. As a result, a film corresponding to a degree that interference color was observed was found in both faces of the substrate and the microfabricated region thereof.

Next, 10 g of hydrogen peroxide as an oxidizing agent was added to 1000 g of a 0.1 mol/L solution of zirconium (IV) chloride (manufactured by KANTO KAGAKU) in water to yield a second metal oxide film forming-solution.

Next, the substrate having the first metal oxide film was heated to 400° C. on a hot plate (manufactured by AS ONE CORPORATION), and a hand spray (Spray Gun No. 8012, manufactured by AS ONE CORPORATION) was used to spray the second metal oxide film forming-solution onto the substrate so as to form a second metal oxide film, thereby yielding a metal oxide film on the substrate.

An X-ray diffraction meter (RINT-1500, manufactured by Rigaku Corporation) was used to measure the metal oxide film yielded by the above-mentioned method. As a result, it was found out that the film was an amorphous film. Thus, the composition of the metal oxide film was analyzed by a photoelectron spectral analyzer (ESCALAB 200i-XL, manufactured by V. G. Scientific Ltd.). As a result, the amount of Zr was 32.8 atomic %, and the amount of oxygen was 68.1 atomic %, and it was verified that a zirconium oxide film was formed. Furthermore, a Loresta (manufactured by Mitsubishi Chemical Corporation) was used to measure the surface resistance of the metal oxide film formed on the substrate. As a result, it was proved that the film had insulation properties.

### Example 2

### Formation of a Zinc Oxide Film on a Copper Substrate Subjected to Microfabrication

In the present example, a zinc oxide film was formed on a copper substrate subjected to microfabrication to give corrosion resistance thereto while keeping the electroconductivity.

First, in the example, a copper (1 mm in thickness) subjected to microfabrication (grooves 50 μm in width, 10 mm in length, and 20 μm in depth) by an etching method was prepared as a substrate.

Next, a borane-dimethylamine complex (manufactured by KANTO KAGAKU) as a reducing agent was added to 1000 g of a 0.05 mol/L solution of zinc acetate (manufactured by KANTO KAGAKU) in ethanol, so as to give a concentration of 0.08 mol/L. Furthermore, thereto was added 1 g of potassium nitrite (manufactured by KANTO KAGAKU) as an auxiliary ion source to yield a first metal oxide film forming-solution.

Next, the first metal oxide film-forming solution was heated up to a temperature of 70° C., and a Naflon Bubbler (manufactured by AS ONE CORPORATION) was used to generate air bubbles at a constant temperature of 70° C. At this time, the first metal oxide film-forming solution was circulated and caused to pass through a filter to remove a precipitation and mixed dusts.

Next, the substrate was ultrasonic-washed with a neutral detergent, and set on a hot plate heated to 90° C. The first metal oxide film forming-solution where air bubbles were generated with a bubbler was caused to flow onto the substrate and was again circulated thereon, and this state was continued for 1 hour for each of the surfaces. Thereafter, the resultant was washed with pure water. As a result, a film corresponding to a degree that interference color was observed was found in both the surfaces of the substrate and the microfabricated region thereof.

Next, 10 g of a surfactant (SURFYNOL485, manufactured by Nissin Chemical Industry Co., Ltd.) was added to 1000 g of a 0.1 mol/L solution of zinc nitrate in water, and further 5 g of a borane-tert-butylamine complex (manufactured by KANTO KAGAKU) as a reducing agent was added thereto so as to yield a second metal oxide film forming-solution.

Next, the substrate having the first metal oxide film was heated to 350° C. on a hot plate (manufactured by AS ONE CORPORATION), and a hand spray (Spray Gun No. 8012, manufactured by AS ONE CORPORATION) was used to spray the second metal oxide film forming-solution onto the substrate so as to form a second metal oxide film, thereby yielding a metal oxide film on the substrate.

The X-ray diffraction meter (RINT-1500, manufactured by Rigaku Corporation) was used to measure the metal oxide film yielded by the above-mentioned method. As a result, it was verified that a zinc oxide film was formed. Furthermore, the Loresta (manufactured by Mitsubishi Chemical Corporation) was used to measure the surface resistance of the zinc oxide film formed on the substrate. As a result, the surface resistance was 100 Ω/□; thus, electroconductivity was verified. The substrate having the zinc oxide film was immersed in a solution of iodine (Wako Pure Chemical Industries, Ltd.) for 24 hours. No change was observed in the substrate; thus, a sufficient corrosion resistance was demonstrated. In a case where a copper substrate having no metal oxide film was immersed in a solution of iodine (Wako Pure Chemical Industries, Ltd.) for 24 hours in the same manner, pore corrosion was observed.

### Comparative Example 1

### Formation of an ITO Film on a Copper Substrate Subjected to Microfabrication by Dip Coating

In the present comparative example, the copper (grooves 50 μm in width, 10 mm in length, and 20 μm in depth) similarly prepared as in Example 2, which was subjected to the microfabrication was used as a substrate.

Next, a 10% solution of ITO fine particles (manufactured by Hosokawa Micron group) in ethanol was prepared, and coated onto the substrate by dip coating. The resultant was fired at 500° C. in an electric muffle furnace (P90, manufactured by Denken Co., Ltd.) for 2 hours, so as to yield an ITO film on the substrate.

The ITO film yielded by the above-mentioned method was immersed in a solution of iodine (Wako Pure Chemical Industries, Ltd.) for 24 hours. As a result, pore corrosion was found out in the same manner as in the substrate subjected to no processing. Thus, a sufficient corrosion resistance was not demonstrated. Furthermore, the Loresta (manufactured by Mitsubishi Chemical Corporation) was used to measure the surface resistance. As a result, the surface resistance was 10000 Ω/□. Thus, it was found out that the resultant was poor in electroconductivity.

### Example 3

### Formation of an ITO Transparent Electrode Film on a Porous Substrate

In the present example, an even and dense ITO transparent electrode film was given to a porous-titanium-oxide-film-attached glass substrate.

First, to water and isopropyl alcohol as solvents were added titanium oxide fine particles having a primary particle diameter of 20 nm (P25, manufactured by Nippon Aerosil Co., Ltd.), acetylacetone, and polyethylene glycol (average molecular weight: 3000) to give concentrations of 37.5% by weight, 1.25% by weight, and 1.88% by weight, respectively. A homogenizer was used to produce a slurry where the above-mentioned sample was dissolved or dispersed. This slurry was coated on a glass substrate by a doctor blade method, the resultant was allowed to stand still for 20 minutes and dried at 100° C. for 30 minutes. Subsequently, the electric muffle furnace (P90, manufactured by Denken Co., Ltd.) was used to fire the substrate with the dried film at 500° C. under an atmospheric pressure for 30 minutes. In this way, the above-mentioned porous-titanium-oxide-film-attached glass substrate was yielded.

Next, a borane-trimethylamine complex (manufactured by KANTO KAGAKU) as a reducing agent was added to 1000 g of a 0.03 mol/L indium chloride and 0.001 mol/L tin chloride solution in water so as to give a concentration of 0.05 mol/L. Furthermore, thereto was added 2 g of nitric acid 1.42 (a 70% solution of nitric acid in water, manufactured by KANTO KAGAKU) as a nitrate ion source to yield a first metal oxide film forming-solution.

Next, the porous-titanium-oxide-film-attached glass substrate was immersed in the above-mentioned solution at a temperature of 80° C. for 2 minutes to yield a first metal oxide film on the substrate. At this time, it was recognized with the naked eye that the white color of titanium oxide turned to yellow.

Next, to 1000 g of a 0.1 mol/L indium chloride and 0.05 mol/L tin chloride solution in mixed ethanol and water (ethanol/water=1/1) were added 2 g of sodium bromate as an auxiliary ion source and 10 g of hydrogen peroxide water as an oxidizing agent to yield a second metal oxide film forming-solution.

Next, the substrate having the first metal oxide film was heated to 300° C. on a hot plate (manufactured by AS ONE CORPORATION), and the hand spray (Spray Gun No. 8012, manufactured by AS ONE CORPORATION) was used to spray the second metal oxide film forming-solution onto the substrate to form a second metal oxide film, thereby yielding a metal oxide film on the substrate. The film was washed with pure water, and the resultant metal oxide film was observed with the naked eye. As a result, gloss which appeared to be based on the formation of a dense metal oxide film was recognized.

The X-ray diffraction meter (RINT-1500, manufactured by Rigaku Corporation) was used to measure the metal oxide film yielded by the above-mentioned method. As a result, it was verified that an ITO film was formed. Furthermore, the Loresta (manufactured by Mitsubishi Chemical Corporation) was used to measure the surface resistance of the ITO film formed on the porous titanium oxide film on the substrate. As a result, it was 0.4 Ω/□. For reference, the same ITO film was formed on a glass substrate having no porous titanium oxide film. As a result, the surface resistance was 0.4 Ω/□, and the transmissibility of the glass surface to all light rays was 86%.

### Comparative Example 2

A porous-titanium-oxide-film-attached glass substrate was similarly prepared as in Example 3 and used, and an ITO transparent electroconductive film was given to this porous substrate by sputtering. Conditions for forming the film was as follows: an electric power of 1.0 kW was applied and oxygen gas was caused to flow at a flow rate of 90 sccm for 5 minutes. As a result, the porous titanium oxide film was peeled from the glass substrate. It appears that the stress of the film by the sputtering was high.

### Comparative Example 3

A porous-titanium-oxide-film-attached glass substrate was similarly prepared as in Example 3 and used, and an ITO transparent electroconductive film was given to this porous substrate by printing. A 10% solution of ITO fine particles (manufactured by Hosokawa Micron group) in ethanol was coated onto the titanium oxide face of the porous-titanium-oxide-film-attached glass substrate by means of a Mayer bar (No. 16). Thereafter, the resultant was allowed to stand still at room temperature for 10 minutes, and dried at 100° C. for 30 minutes. Subsequently, the electric muffle furnace (P90, Denken Co., Ltd.) was used to fire the substrate with the film at 350° C. under an atmospheric pressure for 30 minutes.

The surface resistance of the titanium oxide face of the thus-obtained porous-titanium-oxide-film-attached glass substrate was measured with the Loresta (manufactured by Mitsubishi Chemical Corporation). As a result, a resistance of 5000 Ω/□ was obtained. The film was not dense to exhibit a high resistance. A scanning electron microscope (S-4500, manufactured by Hitachi Ltd.) was used to observe the film. As a result, the film was a porous ITO film.

### Example 4

In the present embodiment, a glass was used as a substrate, and a titanium oxide film was formed on the glass.

First, titanium chloride (TiCl₄) as a metal source was dissolved in a mixed solvent of 80% by volume of water and 20% by volume of isopropyl alcohol (IPA) to prepare a solution having a concentration of 0.06 mol/L in an amount of 1000 g. Thereafter, to the solution was added a borane-dimethylamine complex (manufactured by KANTO KAGAKU) as a reducing agent to give a concentration of 0.1 mol/Lm, thereby yielding a first metal oxide film forming-solution.

Next, while the first metal oxide film forming-solution was kept at a constant temperature of 90° C., the substrate was immersed therein for 12 hours to yield a first metal oxide film on the substrate.

Next, titanium acetylacetonate ((C₃H₇O)₂Ti(C₅H₇O₂)₂) as a metal source was dissolved into 1000 g of a mixed solvent of 10% by volume of water, 80% by volume of IPA and 10% by volume of toluene so as to give a concentration of 0.1 mol/L, thereby yielding a second metal oxide film forming-solution.

Next, the substrate having the first metal oxide film was heated to 380° C. on a hot plate (manufactured by AS ONE CORPORATION), and the hand spray (Spray Gun No. 8012, manufactured by AS ONE CORPORATION) was used to spray the second metal oxide film forming-solution onto the substrate for 3 minutes to form a second metal oxide film, thereby yielding a metal oxide film on the substrate.

The above-mentioned X-ray diffraction meter was used to measure the metal oxide film. As a result, it was verified that a titanium oxide film was formed. Furthermore, the metal oxide film was analyzed by the photoelectron spectral analyzer (ESCALAB 200i-XL, manufactured by V. C. Scientific Ltd.). As a result, it was confirmed that the titanium oxide film was formed. Moreover, the scanning electron microscope (SEM) was used to measure the film thickness of the metal oxide film. As a result, it was 600 nm.

### Examples 5 to 45

In each of Examples 5 to 45, a metal oxide film was formed on a substrate under experimental conditions shown in Tables 1 to 9 described below. The method of forming the metal oxide film, and the method of measuring physical properties thereof were in accordance with those in Example 4. The oxidizing agent and the reducing agent were added when the metal oxide film forming-solution was prepared. For the bubbling, a Naflon Bubbler (manufactured by AS ONE CORPORATION) was used. As the device for irradiating the ultraviolet rays, an HB400X-21 manufactured by SEN LIGHTS CORPORATION was used. As the hand spray, the Spray Gun No. 8012, manufactured by AS ONE CORPORATION, was used. As the Ultrasonic Nebulizer, the NE-U17, manufactured by OMRON HEALTHCARE Co., Ltd., was used.

The glass/TiO₂ substrate was a product of TiO₂ fine particles coated into a paste form onto a glass. The production method thereof is specifically as follows. First, to water and isopropyl alcohol as solvents were added titanium oxide fine particles having a primary particle diameter of 20 nm (P25, manufactured by Nippon Aerosil Co., Ltd.), acetylacetone, and polyethylene glycol (average molecular weight: 3000) to give concentrations of 37.5% by weight, 1.25% by weight, and 1.88% by weight, respectively. A homogenizer was used to produce a slurry where the above-mentioned sample was dissolved or dispersed. This slurry was coated on a glass substrate by a doctor blade method, and the resultant was allowed to stand still for 20 minutes and dried at 1000° C. for 30 minutes. Subsequently, the electric muffle furnace (P90, manufactured by Denken Co., Ltd.) was used to fire the substrate with the dried film at 500° C. under an atmospheric pressure for 30 minutes. In this way, a porous-titanium-oxide-film-attached glass substrate was yielded.

Table 1 shows kinds of the reducing agents, the oxidizing agents, the auxiliary ion sources, and spraying devices used in Tables 2 to 9. Tables 2 to 5 show specific experimental conditions in the first metal oxide film-forming step (metal oxide crystal nucleus forming step) using each of the first metal oxide film forming-solutions. Tables 6 to 9 show specific experimental conditions in the second metal oxide film-forming step (metal oxide film growing step) using each of the second metal oxide film forming-solutions. Each film thickness shown in Tables 6 to 9 shows the total value about each first metal oxide film and the corresponding second metal oxide film. Each of the results in Examples 4 to 45 demonstrated that it was recognized through the photoelectron spectral analyzer (ESCA) that a metal oxide film was formed.

TABLE 1

| | | |
|---|---|---|
| Reducing agent | (1) | Borane-tert-butylamine complex |
| | (2) | Borane-N,N-diethylaniline complex |
| | (3) | Borane-dimethylamine complex |
| | (4) | Borane-trimethylamine complex |
| Oxidizing agent | (1) | Hydrogen peroxide |
| | (2) | Silver oxide |
| | (3) | Dichromic acid |
| | (4) | Potassium permanganese |
| Auxiliary ion source | (1) | Sodium bromate |
| | (2) | Potassium bromate |
| | (3) | Potassium hypobromate |
| | (4) | Sodium hypobromate |
| | (5) | Potassium chlorite |
| | (6) | Sodium hypochlorite |
| | (7) | Potassium nitrate |
| | (8) | Sodium nitrite |
| | (9) | Ammonium perchlorate |
| | (10) | Potassium chlorate |
| Spraying device | (1) | Hand spray |
| | (2) | Ultrasonic Nebulizer |

TABLE 2
Metal oxide crystal nucleus forming step

| | First metal | | | | Reducing | | Oxidizing | | Auxiliary ion | |
|---|---|---|---|---|---|---|---|---|---|---|
| | oxide film | Substrate | Metal source (mol/l) | | agent (mol/l) | | agent (mol/l) | | source (mol/l) | |
| Example 4 | TiO₂ | Glass | TiCl₄ | 0.1 | (3) | 0.1 | — | — | (4) | 0.03 |
| Example 5 | TiO₂ | Glass/TiO₂ | Ti(C₃H₇O)₂(C₆H₉O₃)₂ | 0.03 | (3) | 0.05 | — | — | — | — |
| Example 6 | ZnO | Glass | Zn(CH₃COO)₂•2H₂O | 0.05 | (1) | 0.07 | (1) | 0.001 | — | |
| Example 7 | ZrO₂ | SUS | ZrCl₂O•8H₂O | 0.02 | (3) | 0.01 | — | — | — | — |
| Example 8 | In₂O₃ | Glass | In(NO₃)₃•nH₂O | 0.01 | (3) | 0.1 | — | — | — | — |
| Example 9 | SnO₂ | Glass | SnCl₂•2H₂O | 0.02 | (3) | 0.08 | (1) | 0.001 | — | — |
| Example 10 | CeO₂ | Glass | Ce(CH₃COO)₃•H₂O | 0.05 | (4) | 0.15 | — | — | — | — |
| Example 11 | ITO | Glass/TiO₂ | In(NO₃)₃•nH₂O | 0.01 | (3) | 0.03 | — | — | — | — |
| | | | SnCl₂ | 0.005 | | | | | | |
| Example 12 | Gd—CeO₂ | Glass | Gd(NO₃)₃ | 0.02 | (4) | 0.05 | — | — | — | — |
| | | | Ce(CH₃COO)₃•H₂O | 0.005 | | | | | | |
| Example 13 | Sm—CeO₂ | Glass | Sm(NO₃)₃ | 0.02 | (2) | 0.05 | — | — | (2) | 0.05 |
| | | | Ce(CH₃COO)₃•H₂O | 0.005 | | | | | | |
| Example 14 | CeO₂ | Glass | Ce(NO₃)₃•6H₂O | 0.02 | — | — | — | — | — | — |
| Example 15 | SnO₂ | Glass | SnCl₂•2H₂O | 0.03 | (3) | 0.08 | — | — | — | — |

| | | | | | | | Thermal |
|---|---|---|---|---|---|---|---|
| | | | | Liquid | | | treatment |
| | | UV | | temperature | | | after the film |
| | Solvent | (MW/cm²) | Bubbling | (° C.) | Time | | formation |
| Example 4 | Water 80vol % | — | — | 90 | 12 | h | — |
| | IPA20vol % | | | | | | |
| Example 5 | IPA70vol % | — | — | 80 | 12 | h | — |
| | Toluene 30vol % | | | | | | |
| Example 6 | Water 50vol % | — | — | 90 | 20 | min | — |
| | IPA50vol % | | | | | | |
| Example 7 | Water 50vol % | — | — | 60 | 12 | h | — |
| | IPA50vol % | | | | | | |
| Example 8 | Water 50vol % | — | — | 90 | 50 | min | — |
| | IPA50vol % | | | | | | |
| Example 9 | Water 50vol % | — | — | 90 | 30 | min | — |
| | IPA50vol % | | | | | | |
| Example 10 | Water 50vol % | — | — | 80 | 1 | h | — |
| | IPA50vol % | | | | | | |
| Example 11 | Water 50vol % | — | — | 80 | 8 | h | — |
| | IPA50vol % | | | | | | |
| Example 12 | Water 50vol % | — | — | 90 | 8 | h | — |
| | IPA50vol % | | | | | | |
| Example 13 | Water 50vol % | — | — | 80 | 6 | h | — |
| | IPA50vol % | | | | | | |
| Example 14 | Water 100vol % | 20 | — | 60 | 30 | min | — |
| Example 15 | Water 50vol % | — | Air | 90 | 1 | h | — |
| | IPA50vol % | | | | | | |

TABLE 3
Metal oxide crystal nucleus forming step

| | First metal | | | | Reducing | | Oxidizing | | Auxiliary ion | |
|---|---|---|---|---|---|---|---|---|---|---|
| | oxide film | Substrate | Metal source (mol/l) | | agent (mol/l) | | agent (mol/l) | | source (mol/l) | |
| Example 16 | MgO | Glass | Mg(ClO₄)₂ | 0.02 | (1) | 0.03 | (1) | 0.005 | (10) | 0.002 |
| Example 17 | Al₂O₃ | Silicon | AlCl₃ | 0.08 | (2) | 0.1 | — | — | (9) | 0.01 |
| | | wafer | | | | | | | | |
| Example 18 | SiO₂ | Silicon | (NH₄)₂SiF₆ | 0.02 | (4) | 0.01 | (3) | 0.02 | — | — |
| | | wafer | | | | | | | | |
| Example 19 | V₂O₅ | Glass | VCl₂ | 0.02 | (3) | 0.05 | — | — | (7) | 0.02 |
| Example 20 | MnO₂ | Titanium | Mn(CH₃COO)₂•4H₂O | 0.03 | (2) | 0.03 | — | — | (8) | 0.02 |
| | | plate | | | | | | | | |
| Example 21 | Fe₂O₃ | Silicon | Fe(ClO₄)₃•6H₂O | 0.01 | (3) | 0.01 | — | — | — | — |
| | | wafer | | | | | | | | |
| Example 22 | Co₃O₄ | Silicon | Co(No₃)₂•6H₂O | 0.03 | (1) | 0.03 | — | — | — | — |
| | | wafer | | | | | | | | |
| Example 23 | NiO | Glass/TiO₂ | Ni(CH₃COO)₂•4H₂O | 0.01 | (2) | 0.02 | — | — | (2) | 0.03 |
| Example 24 | CuO | Glass/TiO₂ | Cu(NO₃)₂•3H₂O | 0.01 | (4) | 0.02 | — | — | (9) | 0.01 |
| Example 25 | Y₂O₃ | Glass/TiO₂ | Y(CH₃COO)₃•4H₂O | 0.05 | (2) | 0.01 | — | — | (5) | 0.03 |
| Example 26 | AgO | Glass | AgNO₃ | 0.01 | (1) | 0.05 | (4) | 0.03 | (8) | 0.02 |
| Example 27 | Sm₂O₃ | Glass/TiO₂ | Sm(NO₃)₃•6H₂O | 0.06 | (3) | 0.07 | — | — | (6) | 0.05 |
| Example 28 | PbO₂ | Glass | Pb(ClO₄)₂•3H₂O | 0.02 | (3) | 0.03 | — | — | — | — |

| | | | | | | | Thermal |
|---|---|---|---|---|---|---|---|
| | | | | Liquid | | | treatment |
| | | UV | | temperature | | | after the film |
| | Solvent | (MW/cm²) | Bubbling | (° C.) | Time | | formation |
| Example 16 | Water 20vol % | — | — | 60 | 1 | h | — |
| | ethanol 80vol % | | | | | | |
| Example 17 | Water 20vol % | — | Air | 65 | 24 | h | 1000° C. |
| | ethanol 80vol % | | | | | | 1 h |
| Example 18 | Water 80vol % | — | — | 70 | 12 | h | — |
| | ethanol 20vol % | | | | | | |
| Example 19 | Water 20vol % | 10 | — | 80 | 12 | h | 500° C. |
| | ethanol 80vol % | | | | | | 1 h |
| Example 20 | Water 20vol % | — | — | 50 | 8 | h | — |
| | ethanol 80vol % | | | | | | |
| Example 21 | Water 20vol % | 20 | — | 50 | 10 | h | — |
| | ethanol 80vol % | | | | | | |
| Example 22 | Water 20vol % | — | — | 80 | 24 | h | — |
| | ethanol 80vol % | | | | | | |
| Example 23 | Water 20vol % | 10 | — | 50 | 12 | h | 200° C. |
| | ethanol 80vol % | | | | | | 1 h |
| Example 24 | Water 20vol % | 10 | — | 50 | 5 | h | — |
| | ethanol 80vol % | | | | | | |
| Example 25 | Water 20vol % | 20 | — | 80 | 6 | h | — |
| | ethanol 80vol % | | | | | | |
| Example 26 | Water 20vol % | — | — | 90 | 24 | h | — |
| | ethanol 80vol % | | | | | | |
| Example 27 | Water 20vol % | — | Air | 60 | 10 | h | 500° C. |
| | ethanol 80vol % | | | | | | 1 h |
| Example 28 | Water 20vol % | — | — | 70 | 1 | h | — |
| | ethanol 80vol % | | | | | | |

TABLE 4
Metal oxide crystal nucleus forming step

| | First metal | | | | Reducing | | Oxidizing | | Auxiliary ion | |
|---|---|---|---|---|---|---|---|---|---|---|
| | oxide film | Substrate | Metal source (mol/l) | | agent (mol/l) | | agent (mol/l) | | source (mol/l) | |
| Example 29 | La₂O₃ | Glass/TiO₂ | La(NO₃)₃•6H₂O | 0.02 | (1) | 0.02 | — | — | (8) | 0.01 |
| Example 30 | Ga dope | Silicon | La(NO₃)₃•6H₂O | 0.02 | (3) | 0.03 | — | — | — | — |
| | La₂O₃ | wafer | Ga(NO₃)₃ | 0.005 | | | | | | |
| Example 31 | HfO₂ | SUS | Hf(SO₄)₂ | 0.07 | (1) | 0.1 | — | — | (9) | 0.05 |
| Example 32 | Sc₂O₃ | Glass/TiO₂ | Sc(NO₃)₃•4H₂O | 0.07 | (1) | 0.1 | — | — | — | — |
| Example 33 | Gd₂O₃ | Glass/TiO₂ | Gd(NO₃)₃•6H₂O | 0.05 | (4) | 0.1 | — | — | — | — |
| Example 34 | NiO—YSZ | Silicon | Ni(CH₃COO)₂•4H₂O | 0.03 | (3) | 0.05 | — | — | — | — |
| | | wafer | ZrO(NO₃)₂•2H₂O | 0.03 | | | | | | |
| | | | YCl₃•6H₂O | 0.01 | | | | | | |
| Example 35 | CaO | Glass/TiO₂ | CaCl₂•2H₂O | 0.05 | (3) | 0.05 | (2) | 0.01 | (8) | 0.01 |
| Example 36 | CeO₂ | Glass | Ce(CH₃COO)₃•H₂O | 0.01 | (2) | 0.02 | — | — | — | — |
| Example 37 | CeO₂ | Glass/TiO₂ | Ce₂(SO₄)₃•8H₂O | 0.05 | (3) | 0.05 | — | — | — | — |
| Example 38 | CeO₂ | Glass | Ce(CH₃COO)₃•H₂O | 0.01 | (3) | 0.02 | — | — | — | — |
| Example 39 | CeO₂ | Glass/TiO₂ | CeCl₃•7H₂O | 0.01 | (1) | 0.02 | — | — | — | — |
| Example 40 | CeO₂ | Glass/TiO₂ | Ce₂(CO₃)₃•8H₂O | 0.02 | (1) | 0.02 | — | — | — | — |

| | | | | | | | Thermal |
|---|---|---|---|---|---|---|---|
| | | | | Liquid | | | treatment |
| | | UV | | temperature | | | after the film |
| | Solvent | (MW/cm²) | Bubbling | (° C.) | Time | | formation |
| Example 29 | Water 20vol % | — | — | 80 | 3 | h | — |
| | ethanol 80vol % | | | | | | |
| Example 30 | Water 20vol % | — | — | 70 | 24 | h | — |
| | ethanol 80vol % | | | | | | |
| Example 31 | Water 20vol % | 10 | — | 60 | 24 | h | 400° C. |
| | ethanol 80vol % | | | | | | 1 h |
| Example 32 | Water 20vol % | — | Air | 50 | 24 | h | 500° C. |
| | ethanol 80vol % | | | | | | 1 h |
| Example 33 | Water 20vol % | — | Air | 90 | 10 | h | 500° C. |
| | ethanol 80vol % | | | | | | 1 h |
| Example 34 | Water 20vol % | — | — | 60 | 24 | h | — |
| | ethanol 80vol % | | | | | | |
| Example 35 | Water 20vol % | — | — | 80 | 1 | h | — |
| | ethanol 80vol % | | | | | | |
| Example 36 | Water 20vol % | — | — | 60 | 10 | h | 500° C. |
| | ethanol 80vol % | | | | | | 1 h |
| Example 37 | Water 20vol % | — | — | 40 | 10 | h | 500° C. |
| | ethanol 80vol % | | | | | | 1 h |
| Example 38 | Water 20vol % | — | — | 90 | 2 | h | — |
| | ethanol 80vol % | | | | | | |
| Example 39 | Water 20vol % | — | — | 90 | 12 | h | 500° C. |
| | ethanol 80vol % | | | | | | 1 h |
| Example 40 | Water 20vol % | — | — | 60 | 3 | h | — |
| | ethanol 80vol % | | | | | | |

TABLE 5
Metal oxide crystal nucleus forming step

| | First metal | | | | Reducing | | Oxidizing | | Auxiliary ion | |
|---|---|---|---|---|---|---|---|---|---|---|
| | oxide film | Substrate | Metal source (mol/l) | | agent (mol/l) | | agent (mol/l) | | source (mol/l) | |
| Example 41 | CeO₂ | Glass/TiO₂ | Ce(CH₃COO)₃•H₂O | 0.01 | (2) | 0.02 | (1) | 0.005 | — | — |
| Example 42 | CeO₂ | Glass/TiO₂ | Ce(CH₃COO)₃•H₂O | 0.03 | (3) | 0.05 | — | — | — | — |
| Example 43 | CeO₂ | Glass | Ce(NO₃)₃•6H₂O | 0.01 | (3) | 0.02 | — | — | — | — |
| Example 44 | CeO₂ | Glass/TiO₂ | Ce(NH₄)₂(NO₃)₆ | 0.03 | (3) | 0.03 | — | — | — | — |
| Example 45 | CeO₂ | Glass | Ce(CH₃COO)₃•H₂O | 0.01 | (3) | 0.02 | — | — | — | — |

| | | | | | | | Thermal |
|---|---|---|---|---|---|---|---|
| | | | | Liquid | | | treatment |
| | | UV | | temperature | | | after the film |
| | Solvent | MW/cm²) | Bubbling | (° C.) | Time | | formation |
| Example 41 | Water 20vol % | — | — | 60 | 12 | h | 200° C. |
| | ethanol 80vol % | | | | | | 1 h |
| Example 42 | Water 20vol % | — | — | 80 | 10 | h | — |
| | ethanol 80vol % | | | | | | |
| Example 43 | Water 20vol % | — | — | 60 | 24 | h | — |
| | ethanol 80vol % | | | | | | |
| Example 44 | Water 20vol % | — | — | 80 | 8 | h | 500° C. |
| | ethanol 80vol % | | | | | | 1 h |
| Example 45 | Water 20vol % | — | — | 70 | 6 | h | — |
| | ethanol 80vol % | | | | | | |

TABLE 6
Metal oxide film growing step

| | Second metal | | | Reducing | | Oxidizing | | Auxiliary ion | | |
|---|---|---|---|---|---|---|---|---|---|---|
| | oxide film | Metal source (mol/l) | | agent (mol/l) | | agent (mol/l) | | source (mol/l) | | Solvent |
| Example 4 | TiO₂ | (C₃H₇O)₂Ti(C₅H₇O₂)₂ | 0.1 | — | — | — | — | — | — | ethanol 80vol % |
| | | | | | | | | | | IPA10vol % |
| | | | | | | | | | | Water 10vol % |
| Example 5 | TiO₂ | (C₃H₇O)₂Ti(C₅H₇O₂)₂ | 0.1 | (3) | 0.02 | — | — | — | — | ethanol 80vol % |
| | | | | | | | | | | IPA10vol % |
| | | | | | | | | | | Water 10vol % |
| Example 6 | ZnO | Zn(NO₃)₂ | 0.15 | — | — | (1) | 0.001 | — | — | ethanol 100vol % |
| Example 7 | ZrO₂ | ZrCl₂O•8H₂O | 0.1 | (3) | 0.05 | — | — | — | — | ethanol 100vol % |
| Example 8 | In₂O₃ | In(NO₃)₃•nH₂O | 0.1 | — | — | — | — | — | — | ethanol 80vol % |
| | | | | | | | | | | IPA20vol % |
| Example 9 | SnO₂ | SnCl₂•2H₂O | 0.1 | (3) | 0.01 | (1) | 0.001 | — | — | ethanol 80vol % |
| | | | | | | | | | | methanol 20vol % |
| Example 10 | CeO₂ | Ce(CH₃COO)₃•H₂O | 0.15 | (4) | 0.01 | — | — | — | — | Water 20vol % |
| | | | | | | | | | | Toluene 40vol % |
| | | | | | | | | | | IPA40vol % |
| Example 11 | ITO | In(NO₃)₃•nH₂O | 0.01 | — | — | — | — | — | — | ethanol 100vol % |
| | | SnCl₂ | 0.005 | | | | | | | |
| Example 12 | Gd—CeO₂ | Gd(NO₃)₃ | 0.005 | — | — | — | — | — | — | ethanol 100vol % |
| | | Ce(NO₃)₃•6H₂O | 0.02 | | | | | | | |
| Example 13 | Sm—CeO₂ | Sm(NO₃)₃ | 0.005 | (3) | 0.01 | — | — | — | — | ethanol 100vol % |
| | | CeCl₃•7H₂O | 0.02 | | | | | | | |
| Example 14 | CeO₂ | CeCl₃•7H₂O | 0.2 | — | — | — | — | — | — | ethanol 100vol % |
| Example 15 | SnO₂ | SnCl₂•2H₂O | 0.2 | — | — | — | — | — | — | ethanol 100vol % |

| | | | | | Thermal | | |
|---|---|---|---|---|---|---|---|
| | Substrate | | | Film | treatment | | |
| | temperature | | Spraying | thickness | after the film | XRD | |
| | (° C.) | Time | device | (nm) | formation | crystallinity | ESCA |
| Example 4 | 500 | 3 min | (1) | 600 | — | ∘ | ∘ |
| Example 5 | 320 | 3 min | (1) | 600 | — | ∘ | ∘ |
| Example 6 | 320 | 3 min | (1) | 500 | — | ∘ | ∘ |
| Example 7 | 350 | 3 min | (1) | 1000 | — | x | ∘ |
| Example 8 | 500 | 3 min | (1) | 900 | — | ∘ | ∘ |
| Example 9 | 290 | 3 min | (1) | 900 | — | ∘ | ∘ |
| Example 10 | 380 | 3 min | (1) | 1200 | — | x | ∘ |
| Example 11 | 500 | 3 min | (1) | 600 | — | ∘ | ∘ |
| Example 12 | 500 | 3 min | (1) | 800 | — | ∘ | ∘ |
| Example 13 | 350 | 3 min | (1) | 800 | — | x | ∘ |
| Example 14 | 500 | 3 min | (1) | 300 | — | x | ∘ |
| Example 15 | 500 | 3 min | (1) | 400 | — | ∘ | ∘ |

TABLE 7
Metal oxide film growing step

| | Second metal | | | Reducing | | Oxidizing | | Auxiliary ion | | |
|---|---|---|---|---|---|---|---|---|---|---|
| | oxide film | Metal source (mol/l) | | agent (mol/l) | | agent (mol/l) | | source (mol/l) | | Solvent |
| Example 16 | MgO | Mg(ClO₄)₂ | 0.1 | (4) | 0.01 | (1) | 0.05 | — | — | Water 20vol % |
| | | | | | | | | | | ethanol 80vol % |
| Example 17 | Al₂O₃ | Al(CH₃COCHCOCH₃)₃ | 0.1 | — | — | (1) | 0.05 | — | — | ethanol 10vol % |
| | | | | | | | | | | Toluene 90vol % |
| Example 18 | SiO₂ | (NH₄)₂SiF₆ | 0.1 | — | — | (1) | 0.05 | — | — | Water 80vol % |
| | | | | | | | | | | ethanol 20vol % |
| Example 19 | V₂O₅ | (CH₃COCHCOCH₃)₂VO | 0.2 | — | — | — | — | — | — | ethanol 10vol % |
| | | | | | | | | | | Toluene 90vol % |
| Example 20 | MnO₂ | Mn(CH₃COCHCOCH₃)₃ | 0.1 | — | — | — | — | — | — | ethanol 10vol % |
| | | | | | | | | | | Toluene 90vol % |
| Example 21 | Fe₂O₃ | Fe(CH₃COCHCOCH₃)₃ | 0.2 | — | — | (3) | 0.01 | — | — | ethanol 10vol % |
| | | | | | | | | | | Toluene 90vol % |
| Example 22 | Co₃O₄ | Co(CH₃COCHCOCH₃)₂•2H₂O | 0.1 | — | — | — | — | (5) | 0.03 | ethanol 10vol % |
| | | | | | | | | | | Toluene 90vol % |
| Example 23 | NiO | Ni(CH₃COCHCOCH₃)₂•2H₂O | 0.1 | — | — | — | — | — | — | ethanol 10vol % |
| | | | | | | | | | | Toluene 90vol % |
| Example 24 | CuO | Cu(CH₃COCHCOCH₃)₂ | 0.1 | (2) | 0.01 | — | — | — | — | ethanol 10vol % |
| | | | | | | | | | | Toluene 90vol % |
| Example 25 | Y₂O₃ | Y(CH₃COO)₃•4H₂O | 0.1 | — | — | — | — | — | — | Water 20vol % |
| | | | | | | | | | | ethanol 80vol % |
| Example 26 | AgO | AgNO₃ | 0.1 | — | — | (4) | 0.05 | — | — | Water 20vol % |
| | | | | | | | | | | ethanol 80vol % |
| Example 27 | Sm₂O₃ | Sm(CH₃COCHCOCH₃)₃•2H₂O | 0.1 | — | — | — | — | (8) | 0.01 | Water 20vol % |
| | | | | | | | | | | ethanol 80vol % |
| Example 28 | PbO₂ | Pb(ClO₄)₂•3H₂O | 0.1 | (1) | 0.03 | — | — | — | — | ethanol 10vol % |
| | | | | | | | | | | Toluene 90vol % |

| | | | | | | Thermal | | |
|---|---|---|---|---|---|---|---|---|
| | Substrate | | | | Film | treatment | | |
| | temperature | | | Spraying | thickness | after the film | XRD | |
| | (° C.) | Time | | device | (nm) | formation | crystallinity | ESCA |
| Example 16 | 500 | 1 | h | (1) | 800 | — | x | ∘ |
| Example 17 | 500 | 2 | h | (1) | 2500 | 1000° C. | ∘ | ∘ |
| | | | | | | 1 h | | |
| Example 18 | 450 | 1 | h | (1) | 600 | — | x | ∘ |
| Example 19 | 550 | 1 | h | (2) | 1000 | — | ∘ | ∘ |
| Example 20 | 350 | 50 | min | (2) | 1500 | — | ∘ | ∘ |
| Example 21 | 300 | 30 | min | (2) | 600 | — | ∘ | ∘ |
| Example 22 | 400 | 10 | min | (2) | 500 | — | ∘ | ∘ |
| Example 23 | 450 | 10 | min | (2) | 400 | — | ∘ | ∘ |
| Example 24 | 400 | 5 | min | (2) | 150 | — | ∘ | ∘ |
| Example 25 | 550 | 10 | min | (1) | 200 | — | x | ∘ |
| Example 26 | 450 | 50 | min | (1) | 600 | — | x | ∘ |
| Example 27 | 600 | 40 | min | (2) | 800 | — | ∘ | ∘ |
| Example 28 | 500 | 30 | min | (2) | 400 | — | ∘ | ∘ |

TABLE 8
Metal oxide film growing step

| | Second metal | | | Reducing | | Oxidizing | | Auxiliary ion | | |
|---|---|---|---|---|---|---|---|---|---|---|
| | oxide film | Metal source (mol/l) | | agent (mol/l) | | agent (mol/l) | | source (mol/l) | | Solvent |
| Example 29 | La₂O₃ | La(NO₃)₃•6H₂O | 0.1 | — | — | (1) | 0.05 | — | — | Water 20vol % |
| | | | | | | | | | | ethanol 80vol % |
| Example 30 | Ga dope | La(CH₃COCHCOCH₃)₃•2H₂O | 0.1 | — | — | — | — | — | — | ethanol 10vol % |
| | La₂O₃ | Ga(NO₃)₃ | 0.1 | | | | | | | Toluene 90vol % |
| Example 31 | HfO₂ | Hf(SO₄)₂ | 0.1 | — | — | (1) | 0.05 | — | — | Water 20vol % |
| | | | | | | | | | | ethanol 80vol % |
| Example 32 | Sc₂O₃ | Sc(NO₃)₃•4H₂O | 0.1 | — | — | — | — | — | — | Water 20vol % |
| | | | | | | | | | | ethanol 80vol % |
| Example 33 | Gd₂O₃ | Gd(NO₃)₃•6H₂O | 0.1 | — | — | (1) | 0.05 | — | — | Water 20vol % |
| | | | | | | | | | | ethanol 80vol % |
| Example 34 | NiO•YSZ | Ni(CH₃COO)₂•4H₂O | 0.1 | — | — | — | — | — | — | ethanol 10vol % |
| | | Zr(CH₃COCHCOCH₃)₄ | 0.1 | | | | | | | Toluene 90vol % |
| | | YCl₃•6H₂O | 0.05 | | | | | | | |
| Example 35 | CaO | Ca(CH₃COCHCOCH₃)₂•2H₂O | 0.1 | — | — | (1) | 0.05 | — | — | ethanol 10vol % |
| | | | | | | | | | | Toluene 90vol % |
| Example 36 | Cr₂O₃ | Cr(CH₃COCHCOCH₃)₃ | 0.1 | — | — | — | — | — | — | ethanol 10vol % |
| | | | | | | | | | | Toluene 90vol % |
| Example 37 | Ga₂O₃ | C₃H₉GaO₉S₃ | 0.1 | — | — | — | — | — | — | ethanol 10vol % |
| | | | | | | | | | | Toluene 90vol % |
| Example 38 | SrO | Sr(C₁₁H₁₉O₂)₂ | 0.1 | — | — | — | — | — | — | ethanol 10vol % |
| | | | | | | | | | | Toluene 90vol % |
| Example 39 | Nb₂O₅ | NbCl₅ | 0.1 | — | — | — | — | — | — | Water 20vol % |
| | | | | | | | | | | ethanol 80vol % |
| Example 40 | MoO₃ | Mo(CH₃COCHCOCH₃)₃ | 0.1 | — | — | — | — | — | — | ethanol 10vol % |
| | | | | | | | | | | Toluene 90vol % |

| | | | | | | Thermal | | |
|---|---|---|---|---|---|---|---|---|
| | Substrate | | | | Film | treatment | | |
| | temperature | | | Spraying | thickness | after the film | XRD | |
| | (° C.) | Time | | device | (nm) | formation | crystallinity | ESCA |
| Example 29 | 500 | 20 | min | (1) | 250 | — | x | ∘ |
| Example 30 | 400 | 50 | min | (2) | 800 | — | ∘ | ∘ |
| Example 31 | 300 | 40 | min | (1) | 80 | — | x | ∘ |
| Example 32 | 500 | 1 | h | (1) | 60 | — | x | ∘ |
| Example 33 | 400 | 50 | min | (1) | 150 | — | x | ∘ |
| Example 34 | 350 | 1 | h | (2) | 1500 | — | ∘ | ∘ |
| Example 35 | 400 | 1 | h | (1) | 500 | — | ∘ | ∘ |
| Example 36 | 500 | 30 | min | (2) | 300 | — | ∘ | ∘ |
| Example 37 | 400 | 1 | h | (1) | 250 | — | x | ∘ |
| Example 38 | 600 | 2 | h | (1) | 400 | — | x | ∘ |
| Example 39 | 500 | 2 | h | (1) | 200 | — | x | ∘ |
| Example 40 | 350 | 50 | min | (2) | 100 | — | x | ∘ |

TABLE 9
Metal oxide film growing step

| | Second metal | | | Reducing | | Oxidizing | | Auxiliary ion | | |
|---|---|---|---|---|---|---|---|---|---|---|
| | oxide film | Metal source (mol/l) | | agent (mol/l) | | agent (mol/l) | | source (mol/l) | | Solvent |
| Example 41 | PdO | Pd(CH₃COCHCOCH₃)₂ | 0.1 | — | — | (1) | 0.05 | — | — | ethanol 10 vol % |
| | | | | | | | | | | Toluene 90 vol % |
| Example 42 | Sb₂O₃ | SbCl₃ | 0.1 | — | — | — | — | — | — | Water 20vol % |
| | | | | | | | | | | ethanol 80vol % |
| Example 43 | TeO₂ | K₂TeO₃ | 0.1 | — | — | — | — | — | — | Water 20vol % |
| | | | | | | | | | | ethanol 80vol % |
| Example 44 | BaO | BaCl₂•2H₂O | 0.1 | — | — | — | — | — | — | Water 20vol % |
| | | | | | | | | | | ethanol 80vol % |
| Example 45 | WO₃ | WCl₆ | 0.1 | — | — | — | — | — | — | Water 20vol % |
| | | | | | | | | | | ethanol 80vol % |

| | | | | | | Thermal | | |
|---|---|---|---|---|---|---|---|---|
| | Substrate | | | | Film | treatment | | |
| | temperature | | | Spraying | thickness | after the film | XRD | |
| | (° C.) | Time | | device | (nm) | formation | crystallinity | ESCA |
| Example 41 | 250 | 5 | h | (1) | 300 | — | ∘ | ∘ |
| Example 42 | 500 | 1 | h | (1) | 250 | — | x | ∘ |
| Example 43 | 400 | 1 | h | (2) | 100 | — | x | ∘ |
| Example 44 | 550 | 10 | min | (1) | 50 | — | x | ∘ |
| Example 45 | 350 | 5 | h | (1) | 400 | — | x | ∘ |

### BRIEF DESCRIPTION OF THE DRAWINGS [FIGS. 1A to 1D are an explanatory view illustrating an example of the metal oxide film producing method of the invention.

FIG. 2 is a relationship view (Pourbaix diagram) showing a relationship between pH and electric potential for cerium.

FIG. 3 is an explanatory view illustrating an example of a method of forming a first metal oxide film in the first metal oxide film-forming step.

FIGS. 4A and 4B are each an explanatory view illustrating another example of a method of forming a first metal oxide film in the first metal oxide film-forming step.

FIG. 5 is an explanatory view illustrating yet another example of a method of forming a first metal oxide film in the first metal oxide film-forming step.

FIG. 6 is an explanatory view illustrating still another example of a method of forming a first metal oxide film in the first metal oxide film-forming step.

FIG. 7 is an explanatory view illustrating an example of a method of forming a metal oxide film in the second metal oxide film-forming step.

FIG. 8 is an explanatory view illustrating another example of a method of forming a metal oxide film in the second metal oxide film-forming step.

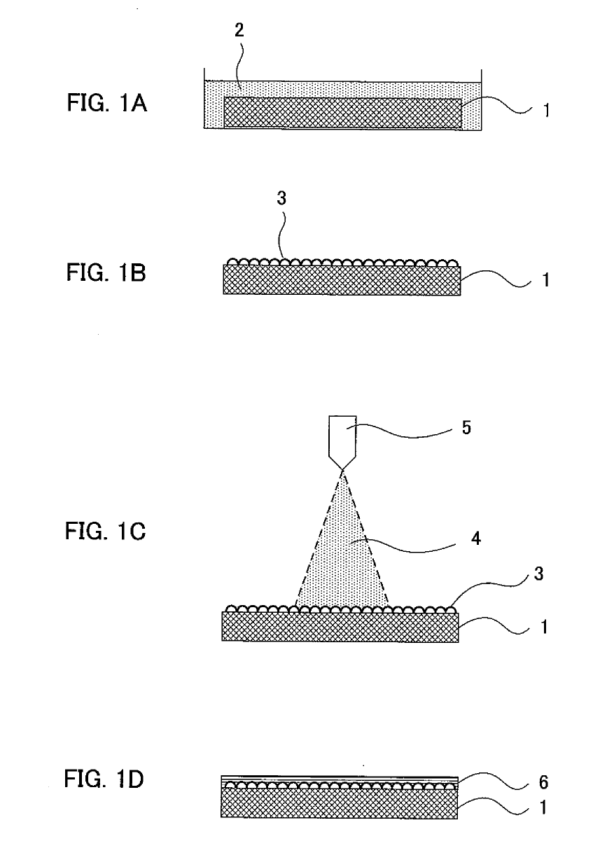

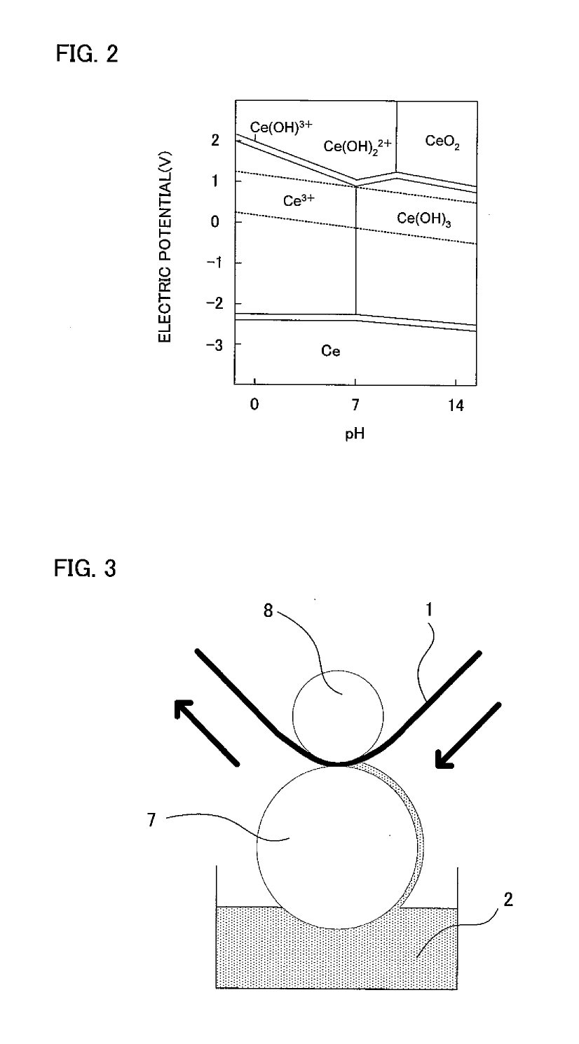

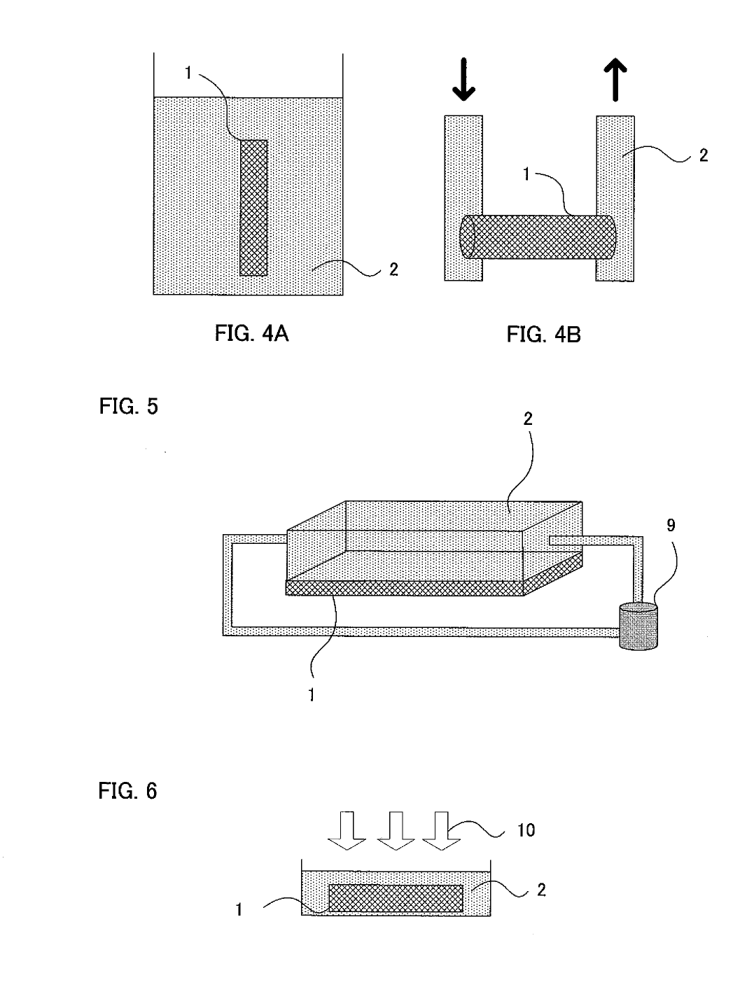

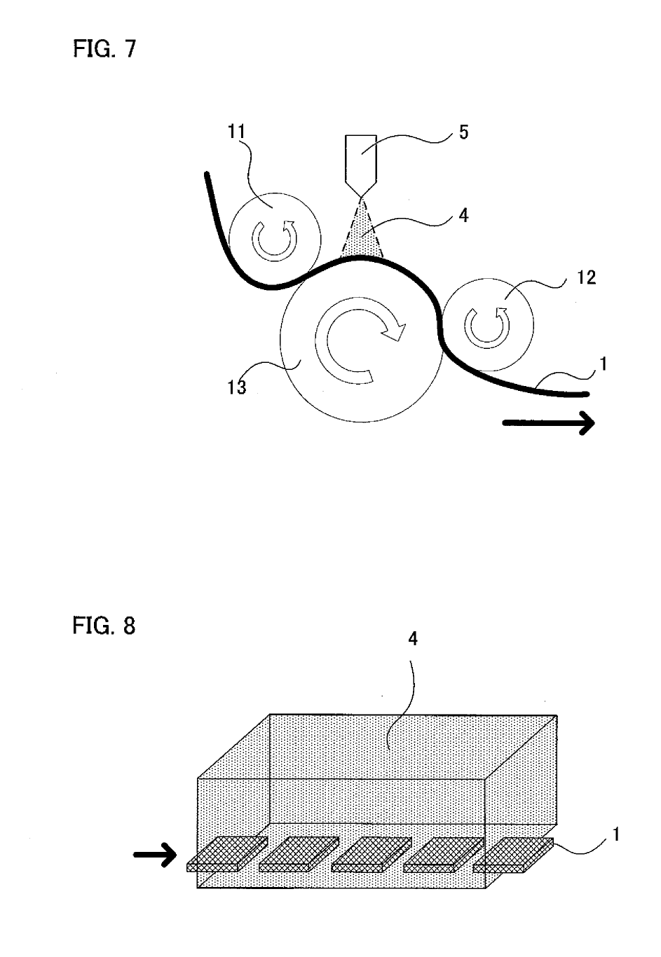

### EXPLANATION OF REFERENCE NUMERALS

1: substrate
2: first metal oxide film-forming solution
3: first metal oxide film
4: second metal oxide film-forming solution
5: spraying device
6: metal oxide film
7 and 8: rollers
9: pump
10: ultraviolet rays
11 to 13: rollers

1. A method of producing a metal oxide film, comprising:
a first metal oxide film-forming step of bringing a substrate into contact with a first metal oxide film forming-solution that has a metal salt or a metal complex as a metal source and at least one of an oxidizing agent and a reducing agent dissolved, and forming a first metal oxide film on the substrate; and
a second metal oxide film-forming step of heating the substrate having the first metal oxide film up to a metal oxide film forming-temperature or higher, bringing the resultant into contact with a second metal oxide film forming-solution that has a metal salt or a metal complex dissolved as a metal source, and yielding a second metal oxide film.

2. The method of producing a metal oxide film according to claim 1, wherein an oxidized gas is mixed at the time of bringing the first metal oxide film forming-solution into contact with the substrate.

3. The method of producing a metal oxide film according to claim 2, wherein the oxidized gas is oxygen or ozone.

4. The method of producing a metal oxide film according to claim 1, wherein ultraviolet rays are irradiated at the time of bringing the first metal oxide film forming-solution into contact with the substrate.

5. The method of producing a metal oxide film according to claim 1, wherein the second metal oxide film forming-solution is sprayed to bring the solution into contact with the substrate having the first metal oxide film.

6. The method of producing a metal oxide film according to claim 1, wherein the second metal oxide film forming-solution comprises at least one of an oxidizing agent and a reducing agent.

7. The method of producing a metal oxide film according to claim 6, wherein the second metal oxide film forming-solution comprises hydrogen peroxide or sodium nitrite as the oxidizing agent.

8. The method of producing a metal oxide film according to claim 6, wherein the second metal oxide film forming-solution comprises a borane-based complex as the reducing agent.

9. The method of producing a metal oxide film according to claim 1, wherein the metal source used in the first metal oxide film-forming solution comprises at least one metal element selected from the group consisting of Mg, Al, Si, Ca, Ti, V, Mn, Fe, Co, Ni, Cu, Zn, Y, Zr, Ag, In, Sn, Ce, Sm, Pb, La, Hf, Sc, Gd, and Ta.

10. The method of producing a metal oxide film according to claim 6, wherein the metal source used in the second first metal oxide film-forming solution comprises at least one metal element selected from the group consisting of Mg, Al, Si, Ca, Ti, V, Mn, Fe, Co, Ni, Cu, Zn, Y, Zr, Ag, In, Sn, Ce, Sm, Pb, La, Hf. Sc, Gd, and Ta.

11. The method of producing a metal oxide film according to claim 1, wherein the metal source used in the second metal oxide film-forming solution comprises at least one metal element ion species selected from the group consisting of Mg, Al, Si, Ca, Ti, V, Mn, Fe, Co, Ni, Cu, Zn, Y, Zr, Ag, In, Sn, Ce, Sm, Pb, La, Hf, Sc, Gd, Ta, Cr, Ga, Sr, Nb, Mo, Pd, Sb, Te, Ba and W.

12. The method of producing a metal oxide film according to claim 6, wherein the metal source used in the second metal oxide film forming-solution comprises at least one metal element selected from the group consisting of Ma, Al, Si, Ca, Ti, V, Mn, Fe, Co, Ni, Cu, Zn, Y, Zr, Ag, In, Sn, Ce, Sm, Pb, La, Hf, Sc, Gd, Ta, Cr, Ga, Sr, Nb, Mo, Pd, Sb, Te, Ba and W.

13. The method of producing a metal oxide film according to claim 1, wherein at least one of the first metal oxide film-forming solution and the second metal oxide film-forming solution comprises at least one ion species selected from the group consisting of a chlorate ion, a perchlorate ion, a chlorite ion, a hypochlorite ion, a bromate ion, a hypobromate ion, a nitrate ion, and a nitrite ion.

14. The method of producing a metal oxide film according to claim 6, wherein at least one of the first metal oxide film-forming solution and the second metal oxide film-forming solution comprises at least one ion species selected from the group consisting of a chlorate ion, a perchlorate ion, a chlorite ion, a hypochlorite ion, a bromate ion, a hypobromate ion, a nitrate ion, and a nitrite ion.

15. The method of producing a metal oxide film according to claim 1, wherein the second metal oxide film forming-solution further comprises a ceramic fine particle.

16. The method of producing a metal oxide film according to claim 6, wherein the second metal oxide film forming-solution further comprises a ceramic fine particle.
